(19) United States
(12) Patent Application Publication
(10) Pub. No.: US 2022/0207295 A1
(43) Pub. Date: Jun. 30, 2022

(54) PREDICTING OCCURRENCES OF TEMPORALLY SEPARATED EVENTS USING ADAPTIVELY TRAINED ARTIFICIAL INTELLIGENCE PROCESSES

(71) Applicant: The Toronto-Dominion Bank, Toronto (CA)

(72) Inventors: Ilya STANEVICH, Toronto (CA); Saba Zuberi, Toronto (CA); Nicole Louise Cox, London (CA); Nadia Pok-Ah Wong, Toronto (CA); Elham Hajarian, Toronto (CA); Maksims Volkovs, Toronto (CA); Tomi Johan Poutanen, Toronto (CA)

(21) Appl. No.: 17/218,558

(22) Filed: Mar. 31, 2021

Related U.S. Application Data
(60) Provisional application No. 63/133,063, filed on Dec. 31, 2020.

(51) Int. Cl. G06K 9/62

(52) U.S. Cl. CPC G06K 9/6256; G06K 9/6264; G06K 9/6282; G06K 9/6277

(57) ABSTRACT

The disclosed embodiments include computer-implemented apparatuses and methods that predict occurrences of temporally separated events using adaptively trained artificial intelligence processes. For example, an apparatus may generate an input dataset based on first interaction data that characterizes an occurrence of a first event, and may apply a trained artificial intelligence process to the input dataset. Based on the application of the trained artificial intelligence process to the input dataset, the apparatus may generate output data representative of a predicted likelihood of an occurrence of a second event within a predetermined time period subsequent to the occurrence of the first event, and may transmit the output data to a computing system. The computing system may generate second interaction data specifying an operation associated with the occurrence of the first event based on the output data, and perform the operation in accordance with the second interaction data.

### CROSS-REFERENCE TO RELATED APPLICATION

This application claims the benefit of priority under 35 U.S.C. § 119(e) to prior U.S. Provisional Application No. 63/133,063, filed Dec. 31, 2020, the disclosure of which is incorporated by reference herein to its entirety.

### TECHNICAL FIELD

The disclosed embodiments generally relate to computer-implemented systems and processes that facilitate a prediction of occurrences of temporally separated events using adaptively trained artificial intelligence processes.

### BACKGROUND

Today, many financial institutions extend credit in the form of credit-card accounts, personal loans, and other unsecured lines-of-credit to their customers in accordance with certain terms and conditions, such as a repayment schedule or corresponding interest rate. The terms and conditions associated with the extended credit may be established initially by the financial institutions prior to issuing the credit-card accounts, personal loans, and unsecured lines-of-credit to corresponding ones of the customers and further, the financial institutions may elect to modify one or more of the terms and conditions of the extended credit based on an evolution in the relationships between the financial institutions and the customers, and based on the customer's use, or misuse, of various financial or credit instruments issued by these financial institutions.

### SUMMARY

In some examples, an apparatus includes a memory storing instructions, a communications interface, and at least one processor coupled to the memory and the communications interface. The at least one processor is configured to execute the instructions to generate an input dataset based on elements of first interaction data. The elements of first interaction data characterize an occurrence of a first event. The at least one processor is further configured to execute the instructions to apply a trained artificial intelligence process to the input dataset, and based on the application of the trained artificial intelligence process to the input dataset, generate output data representative of a predicted likelihood of an occurrence of a second event within a predetermined time period subsequent to the occurrence of the first event. The at least one processor is further configured to execute the instructions to transmit at least a portion of the generated output data to a computing system via the communications interface. The computing system is configured to generate second interaction data specifying an operation associated with the occurrence of the first event based on the portion of the output data, and perform the operation in accordance with the second interaction data.

In other examples, a computer-implemented method includes generating, using at least one processor, an input dataset based on elements of first interaction data. The elements of first interaction data characterize an occurrence of a first event. The computer-implemented method also includes, using the at least one processor, applying a trained artificial intelligence process to the input dataset, and based on the application of the trained artificial intelligence process to the input dataset, generating output data representative of a predicted likelihood of an occurrence of a second event within a predetermined time period subsequent to the occurrence of the first event. Further, the computer-implemented method includes transmitting, using the at least one processor, at least a portion of the generated output data to a computing system. The computing system is configured to generate second interaction data specifying an operation associated with the occurrence of the first event based on the portion of the output data, and perform the operation in accordance with the second interaction data.

Further, in some examples, an apparatus includes a memory storing instructions, a communications interface, and at least one processor coupled to the memory and the communications interface. The at least one processor is configured to execute the instructions to transmit elements of first interaction data to a computing system via the communications interface. The elements of first interaction data characterize an occurrence of a first event. The at least one processor is further configured to execute the instructions to receive elements of output data from the computing system via the communications interface. The elements of output data are representative of a predicted likelihood of an occurrence of a second event within a predetermined time period subsequent to the occurrence of the first event; and the computing system is configured to generate the elements of output data based on an application of a trained artificial intelligence process to an input dataset comprising a subset of the elements of first interaction data. Based on the elements of output data, the at least one processor is further configured to execute the instructions to generate elements of second interaction data that specify one or more operations associated with the occurrence of the first event, and to perform operations that implement the one or more specified operations in accordance with the elements of second interaction data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1A, 1B, and 1C are block diagrams illustrating portions of an exemplary computing environment, in accordance with some exemplary embodiments.

FIGS. 1D and 1E are diagrams of exemplary timelines for adaptively training a machine-learning or artificial intelligence process, in accordance with some exemplary embodiments.

FIGS. 2A and 2B are block diagrams illustrating additional portions of the exemplary computing environment, in accordance with some exemplary embodiments.

FIG. 3 is a flowchart of an exemplary process for adaptively training a machine learning or artificial intelligence process, in accordance with some exemplary embodiments.

FIG. 4 is a flowchart of an exemplary process for predicting a likelihood of occurrences of temporally separated events based on an application of an adaptively trained machine-learning or artificial-intelligence process to input datasets, in accordance with some exemplary embodiments.

FIG. 5 is a flowchart of an exemplary process 500 for determining and implementing a remediation process or treatment, in accordance with some exemplary embodiments.

Like reference numbers and designations in the various drawings indicate like elements.

### DETAILED DESCRIPTION

Modern financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services. For example, one or more computing systems of a financial institution may obtain, generate, and maintain elements of customer profile data identifying the customer and characterizing the customer's relationship with the financial institution, elements of account data identifying and characterizing one or more financial products issued to the customer by the financial institution, elements of transaction data identifying and characterizing one or more transactions involving these issued financial products, or elements of reporting data, such as credit-bureau data associated with the particular customer. The elements of customer profile data, account data, transaction data, and/or reporting data may establish collectively a time-evolving risk profile for the customer, and the financial institution may base not only a decision to provision the particular financial product or service to the corresponding customer, but also a determination of one or more terms and conditions of the provisioned financial product or service, on the established risk profile.

The particular financial product or service may include an secured or unsecured credit product, such as, but not limited to, a credit-card account, a home mortgage, an auto loan, an unsecured personal loan, a secured or unsecured line-of-credit, and/or an overdraft protection (ODP) product, and the initial terms and conditions imposed on the secured or unsecured credit product may include, but are not limited to, an amount of credit extended to the customer, a repayment schedule, an interest rate, or a penalty imposed upon the customer by the financial institution in response to a determined violation of the initial terms or conditions. By way of example, and for a credit-card account issued to the customer, the terms and conditions may include a repayment schedule specifying that a minimum monthly payment for the credit-card account (e.g., a sum of any accrued interest and a portion of a principal balance, etc.) is due at the financial institution on or before the eleventh day of each month, a variable annual percentage rate (APR), and a specified increase in the variable APR in response to the determined violation of the initial terms or conditions.

Further, in some examples, one or more customers that hold the secured or unsecured credit products may fail to submit the required monthly payment to the financial institution in accordance with the corresponding repayment schedule (e.g., on or before a corresponding due date), and based on the failure to submit the required monthly payment, each of these secured or unsecured credit products may become “past due,” e.g., as of the corresponding due date of the required monthly payment. The failure to submit the required monthly payment associated with one or more of the credit products by the corresponding due date may, for example, represent an occurrence of a “delinquency event” involving a corresponding one of the products and a corresponding one of the customers of the financial institution, and each of the delinquency events may remain pending until resolution by the corresponding one of the customers of the financial institution or by the financial institution. Examples of potential resolutions to these delinquency events may include, among other things, a repayment of a past-due balance by a corresponding one of the customers, by a settlement negotiated between the financial institution and a corresponding one of the customers, a personal bankruptcy filing by the corresponding one of the customers, or a write-off of a past-due balance by the financial institution.

The failure of these customers to submit the required monthly payment may result from carelessness or a lapse of memory on the part of the customers, or may be indicative of financial distress on the part of the customers. Furthermore, the underlying, or root, causes of the occurrences of these delinquency events may be indicative of a speed and an ease at which these delinquency events are resolved by the corresponding ones of the customers and the financial institution, either individually or through collection action. For example, for a missed payment resulting from a mere lapse of memory on the part of a corresponding customer, the associated delinquency event may be resolved rapidly and without significant intervention by the financial institution. Alternatively, if the delinquency event were triggered by the customer's financial distress, an early and significant intervention by the financial institution, e.g., through the application of one or more remediation processes or treatments, may be necessary to resolve the delinquency event or to reduce an exposure of the financial institution to losses resulting from the delinquency event.

In some examples, to mitigate an exposure of the financial institution to losses from pending delinquency events involving a variety of credit products, one or more computing systems of the financial institution may perform operations that, in real-time and contemporaneously with the occurrences of each of the pending delinquency events, characterize a credit exposure or a credit risk associated with each of the pending delinquency events, determine an expected timeline for resolving each of the pending delinquency events, and identify one or more of the remediation processes or treatments that, when applied to corresponding ones of the pending delinquency events, resolve the pending delinquency event or reduce a potential financial impact of the pending delinquency event on the financial institution. The determination of the expected timeline for resolving each of the pending delinquency events may, in many instances, depend on the underlying, customer-specific events that trigger the pending delinquency events, such as memory lapse of financial distress, and many existing rules-based processes implemented by the computing systems of the financial institution to characterize the expected resolution time and identify the appropriate remediation processor treatment rely on coarse, global metrics of customer behavior, such as the customer's credit score or payment history, and not on inferences in the customer's saving, spending, or purchasing habits that could separate true financial distress from mere forgetfulness. Additionally, these rules-based processes are often implemented upon detection of an occurrence of corresponding delinquency event, and may be incapable of analyzing, or accounting for, changes in customer behavior during the pendency of the delinquency event.

Further, many existing adaptive techniques for discerning the underlying, customer-specific events that trigger the pending delinquency events, and for predicting the expected resolution time for the pending delinquency events, may be specific to certain credit products, or types of credit products, and may require iterative application to corresponding sets of input data characterizing one or more delinquency events involving the specific credit products, or specific types of credit products. The computational time required to adaptively train and deploy these adaptive techniques (e.g., machine-learning processes, artificial-intelligence processes, stochastic statistical processes, etc.) for a single credit product or a single type of credit product, when repeated across the variety of credit products and types of credit products available at the financial institution, may render impractical any real-time discernment of the underlying, customer-specific events that trigger the pending delinquency events or any prediction of the expected resolution time for these pending delinquency events. Further, as these adaptive techniques are often trained against elements of training data that characterize an initial occurrence of a delinquency event, these existing adaptive techniques may be inappropriate for deployment against input datasets characterizing changes in customer behavior during the pendency of the delinquency event and subsequent to the initial occurrence.

In some examples, described herein, a machine-learning or artificial-intelligence process may be adaptively trained to predict a likelihood of an occurrence of a default event involving a customer of the financial institution and a credit product held by the customer within a predetermined time period subsequent to an occurrence of a delinquency event involving that customer and credit product. As described herein, the delinquency event involving the customer of the financial institution and the credit product issued by that financial institution may occur when the customer fails to submit a scheduled payment associated with the credit product, e.g., when that scheduled payment becomes “past due.” Further, the default event involving the customer and the credit product may occur when the scheduled payment remains past due for a past-due period, such as, but not limited to, ninety calendar days.

As described herein, the machine-learning or artificial-intelligence process may include an ensemble or decision-tree process, such as a gradient-boosted decision-tree process (e.g., XGBoost model), and certain of the exemplary training and validation processes described herein may generate, and utilize, training datasets associated with a first prior temporal interval (e.g., a “training” interval), and using validation datasets associated with a second, and distinct, prior temporal interval (e.g., an out-of-time “validation” interval). In some examples, the training and validation data may include elements of data, e.g., feature values, characterizing customers of the financial institution associated with delinquency events involving not a single credit product or single type of credit product, by a plurality of different credit products and different types of credit products issued to the customers of the financial institution.

Through the implementation of the exemplary processes described herein, one or more computing systems of the financial (e.g., which may collectively establish a distributed computing cluster associated with the financial institution) may perform operations that adaptively, and concurrently, train the machine-learning or artificial-intelligence process to predict the likelihood of the occurrences of the default event across the plurality of issued credit products based on the corresponding subsets of the training and validation data. Further, the trained machine-learning or artificial-intelligence process (e.g., the trained gradient-boosted, decision-tree process described herein) may further ingest input datasets associated with one or more customers of the financial institution that are associated with a corresponding, pending delinquency event involving a corresponding credit product issued by the financial institution. Based on an application of the trained gradient-boosted, decision-tree process to the input datasets, the one or more FI computing systems may generate, at any point during the pendency of the delinquency event, and in accordance with a predetermined temporal schedule (e.g., at or before a predetermined time on a daily basis), elements of output data indicative of a likelihood of an occurrence of a default event involving the corresponding customer and the corresponding credit product within a predetermined time period subsequent to an occurrence of the corresponding delinquency event.

Certain of these exemplary processes, which adaptively train and validate a gradient-boosted, decision-tree process using customer-specific training and validation datasets associated with respective training and validation periods, and which apply the trained and validated gradient-boosted, decision-tree process to additional customer-specific input datasets, may enable the one or more computing systems of the financial institution to predict, at any time during the pendency of a delinquency event involving a customer and a credit product, a likelihood of an occurrence a default event involving the customer and the credit product within a predetermined time period subsequent to an occurrence of the delinquency event (e.g., via an implementation of one or more parallelized, fault-tolerant distributed computing and analytical protocols across clusters of graphical processing units (GPUs) and/or tensor processing units (TPUs)). These exemplary processes may, for example, be implemented in addition to, or as alternative to, existing processes through which the one or more computing systems implement rules-based processes that analyze the coarse metrics of customer behavior, of through which the one or more computing systems train multiple, product-specific adaptive processes trained against data characterizing an initial occurrence of the delinquency event. Further, one or more of the exemplary processes described herein provide, to the financial institution, a real-time indication of the likelihood of an occurrence of a default event subsequent to a delinquency event involving one or more customers, which may inform a determination and application of one or more remediation processes or treatments the mitigate the potential occurrence of the default event or resolve the delinquency event.

Furthermore, and based on the application of the trained and validated gradient-boosted, decision-tree processes to input datasets characterizing customers of the financial institution associated with corresponding delinquency events, certain of these exemplary processes may enable the one or more computing systems of the financial institution to generate, at or before a predetermined time on a daily basis, elements of output data characterizing a predicted likelihood of an occurrence of a default event involving respective ones of the customers within a predetermined time period subsequent to an occurrence of the corresponding delinquency event (e.g., via the implementation of one or more of the parallelized, fault-tolerant distributed computing and analytical protocols described herein across clusters of graphical processing units (GPUs) and/or tensor processing units (TPUs)). These exemplary processes may, for example, be implemented by the one or more computing systems of the financial institution in addition to, or as an alternative to, other predictive processes that rely on data consolidation, pre-processing, and aggregation processes capable of generating the customer-specific input datasets, or generating the elements of predicted output, at reduced temporal frequencies, such as, but not limited to, on a weekly basis, on a monthly basis, or on a quarterly basis.

### A. Exemplary Processes for Adaptively Training Gradient-Boosted, Decision Tree Processes in a Distributed Computing Environment

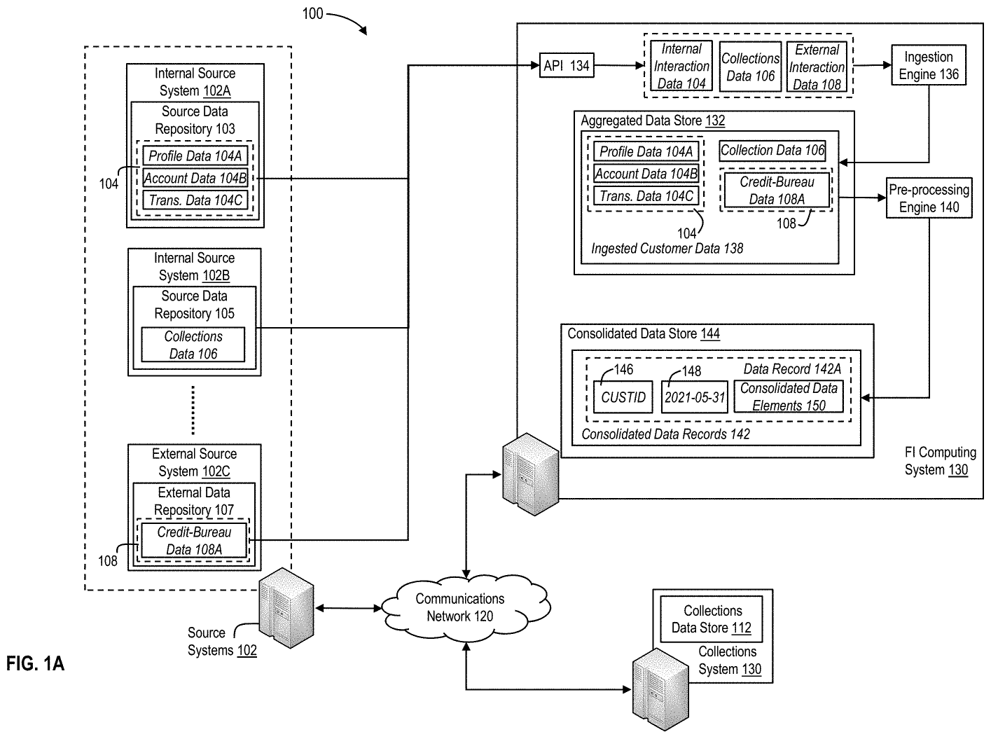

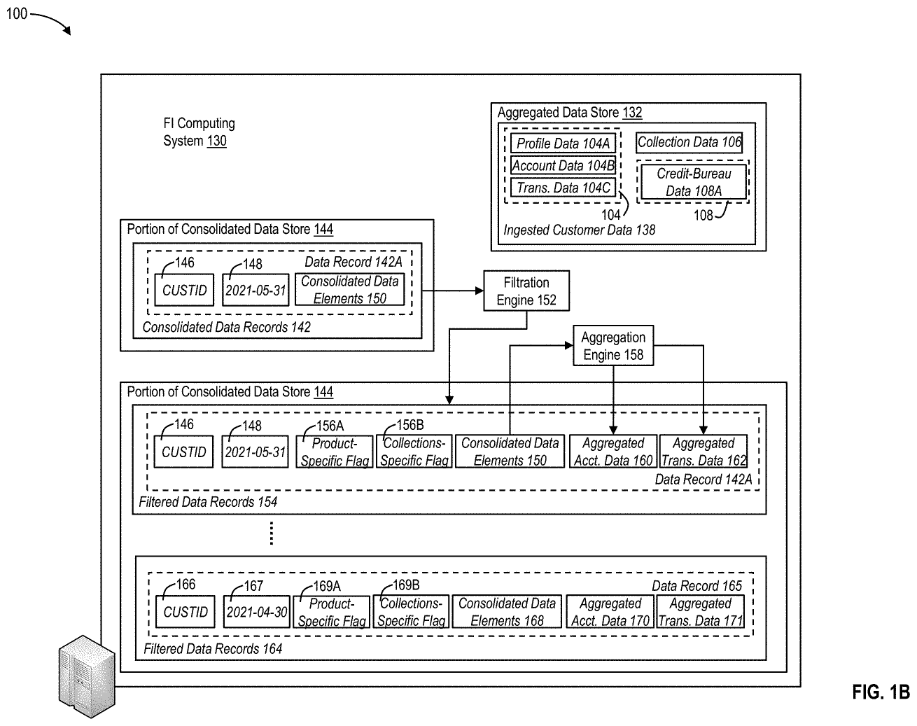

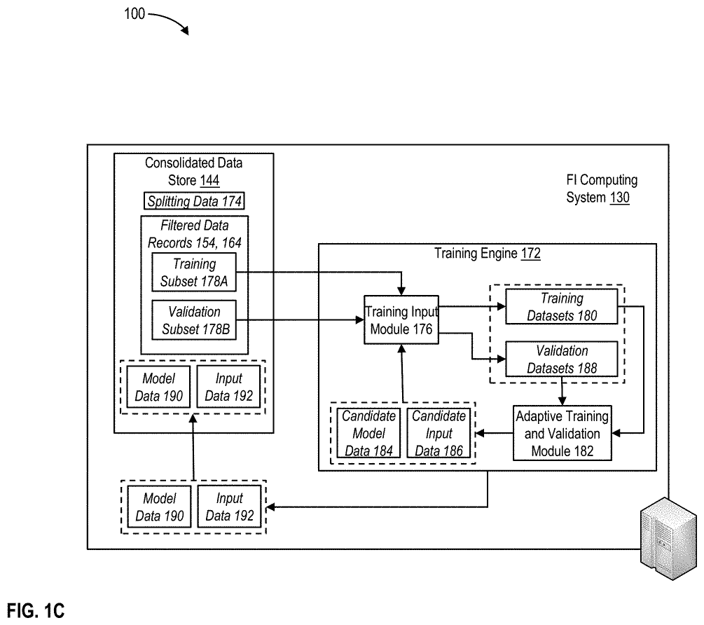

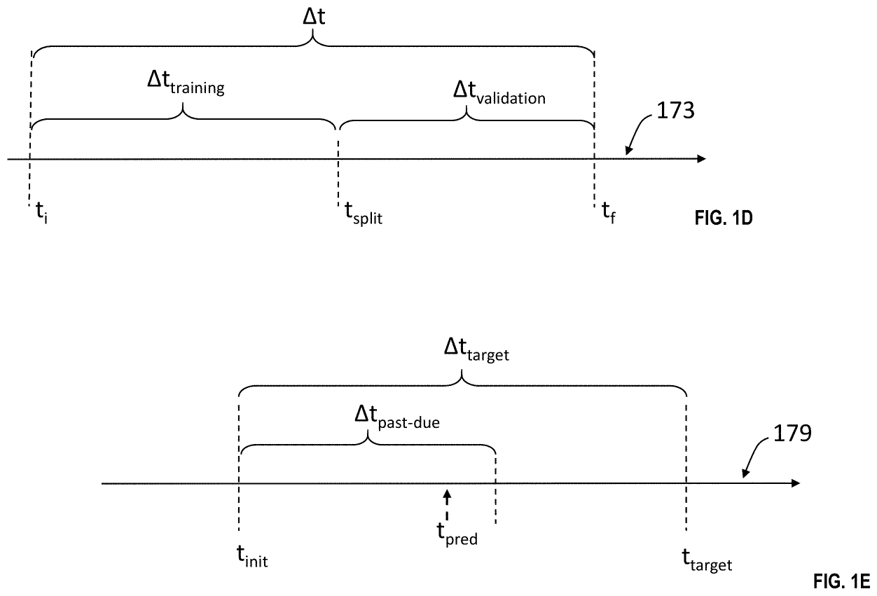

FIGS. 1A, 1B, and 1C illustrate components of an exemplary computing environment 100, in accordance with some exemplary embodiments. For example, as illustrated in FIG. 1A, environment 100 may include one or more source systems 102, such as, but not limited to, internal source system 102A, internal source system 102B, and external source system 102C and one or more computing systems associated with, or operated by, a financial institution, such as collections system 110 and financial institution (FI) computing system 130. In some instances, each of source systems 102 (including internal source system 102A, internal source system 102B, and external source system 102C), collections system 110, and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 102 (including internal source system 102A, internal source system 102B, and external source system 102C), collections system 110, and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Further, each of source systems 102 (including internal source system 102A, internal source system 102B, and external source system 102C), collections system 110, and FI computing system 130 may also include a communications interface, such as one or more wireless transceivers, coupled to the one or more processors for accommodating wired or wireless internet communication with other computing systems and devices operating within environment 100.

Further, in some instances, source systems 102 (including internal source system 102A, internal source system 102B, and external source system 102C), collections system 110, and FI computing system 130 may each be incorporated into a respective, discrete computing system. In additional, or alternate, instances, one or more of source systems 102 (including internal source system 102A and external source system 102C), collections system 110, and FI computing system 130 may correspond to a distributed computing system having a plurality of interconnected, computing components distributed across an appropriate computing network, such as communications network 120 of FIG. 1A. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™, Amazon Web Services™, Google Cloud™, or another third-party provider.

In some instances, FI computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein, in accordance with a predetermined temporal schedule, to ingest elements of data associated with the customers of the financial institution, to preprocess the ingested data elements by filtering, aggregating, downsampling, and/or consolidating certain portions of the ingested data elements, and to store the preprocessed data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process (e.g., the gradient-boosted, decision-tree process described herein) using corresponding training and validation datasets extracted from temporally distinct subsets of the preprocessed data elements, but also apply the adaptively trained machine learning or artificial intelligence process to customer-specific input datasets and generate, in real time, and for a subset of the customers associated with a corresponding delinquency event involving a credit product, elements of output data indicative of a likelihood of an occurrence of a default event involving each of the subset of the customers during a predetermined time period subsequent to an occurrence of the corresponding delinquency event. The implementation of the parallelized, fault-tolerant distributed computing and analytical protocols described herein across the one or more GPUs or TPUs included within the distributed components of FI computing system 130 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

By way of example, and as described herein, a delinquency event involving a customer of the financial institution and a credit product issued by that financial institution may occur when the customer fails to submit a scheduled payment associated with the credit product (e.g., when that scheduled payment becomes “past due”), and a default event involving the particular customer and the credit product may occur when the scheduled payment remains past due for a period of ninety calendar days. In some instances, and through the implementation of the parallelized, fault-tolerant distributed computing and analytical protocols described herein, the distributed components of FI computing system 130 may perform operations in parallel that apply the adaptively trained machine learning or artificial intelligence process to an input dataset associated with the customer and generate, in real time, an element of output indicative of a likelihood of an occurrence of the default event involving the customer and the credit product within the predetermined time period (such as, but not limited to, 119 calendar days) subsequent to the occurrence of the delinquency event involving that customer and credit product.

Referring back to FIG. 1A, each of source systems 102 may maintain, within corresponding tangible, non-transitory memories, a data repository that includes confidential data associated with the customers of the financial institution, and collections system 110 may maintain a collections data store 112 within a portion of one or more tangible, non-transitory memories. For example, internal source system 102A may be associated with, or operated by, the financial institution, and may maintain, within the corresponding one or more tangible, non-transitory memories, a source data repository 103 that includes one or more elements of internal interaction data 104. In some instances, internal interaction data 104 may include data that identifies or characterizes one or more customers of the financial institution and interactions between these customers and the financial institution, and examples of the confidential data include, but are not limited to, customer profile data 104A, account data 104B, and transaction data 104C.

In some instances, customer profile data 104A may include a plurality of data records associated with, and characterizing, corresponding ones of the customers of the financial institution. By way of example, and for a particular customer of the financial institution, the data records of customer profile data 104A may include, but are not limited to, one or more unique customer identifiers (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing the relationship between the particular customer and the financial institution. Further, customer profile data 104A may also include, for the particular customer, multiple data records that include corresponding elements of temporal data (e.g., a time or date stamp, etc.), and the multiple data records may establish, for the particular customer, a temporal evolution in the customer residence or a temporal evolution in one or more of the demographic parameter values.

Account data 104B may also include a plurality of data records that identify and characterize one or more financial products or instruments issued by the financial institution to corresponding ones of the customers. For example, the data records of account data 104B may include, for each of the financial products issued to corresponding ones of the customers, one or more identifiers of the issued financial product or instrument (e.g., an account number, expiration data, card-security-code, etc.), one or more unique customer identifiers (e.g., an alphanumeric character string, such as a login credential, a customer name, etc.), information identifying a product type that characterizes the issued financial product or instrument, and additional information characterizing a balance or current status of the financial product or instrument (e.g., payment due dates or amounts, delinquent accounts statuses, etc.).

Examples of the issued financial products or instruments, and their corresponding product types, may include, but are not limited to, a demand deposit account (e.g., a savings account, a checking account), a term deposit account (e.g., a certificate of deposit), an investment or brokerage account, a retirement accounts, and a credit product, such as a credit-card account, a home mortgage, an auto loan, an unsecured personal loan, a secured or unsecured line-of-credit, and/or an overdraft protection (ODP) product. In some instances, and in addition to specifying the one or more identifiers of the credit products and the additional information characterizing the balance or current status of the credit products, the data records of account data 104B may also identify, for each of the credit products, one or more terms and conditions that include, but are not limited to, an amount of credit extended to the corresponding customer, a repayment schedule, an interest rate, or a penalty imposed upon the corresponding customer by the financial institution in response to a determined violation of the terms or conditions.

Transaction data 104C may include data records that identify, and characterize, purchase transactions initiated by, and involving, customers of the financial institution. Each of the purchase transactions may, for example, be initiated by a customer of the financial institution and involve a corresponding counterparty (e.g., a merchant, retailer, or other business that offers products or services for sale), and may be funded by a corresponding one of the financial products or instruments issued by the financial institution and held by that customer, such as, but not limited to, the credit products described herein. By way of example, and for a particular one or more initiated purchase transactions, the data records of transaction data 104C may include information that identifies, among other things, a corresponding customer (e.g., an alphanumeric customer identifier, etc.), a transaction time or date (e.g., a time or date at which the corresponding customer initiated the particular purchase transaction), a counterparty to the particular purchase transaction (e.g., a counterparty name, etc.), a financial product or instrument that funds the corresponding purchase transaction (e.g., a portion of a tokenized account number of a credit-card account, etc.), and one or more transaction parameters that characterize the corresponding purchase transaction. In some instances, the transaction parameters may include, but are not limited, to a transaction amount associated with the corresponding transaction, an identifier of one or more products or services involved in the purchase transaction (e.g., a product name, a universal product code (UPC), etc.), or additional information describing the counterparty, such as a counterparty location, a standard industrial classification (SIC) code, or a merchant classification code (MCC) associated with the corresponding counterparty.

These disclosed embodiments are not limited to these exemplary purchase transactions or exemplary data records, and in other instances, the data records of transaction data 104C may include any additional, or alternate, number of discrete, structured or unstructured data that identify and characterize any additional or alternate purchase transaction capable of initiation by the customer of the financial institution, and may include any additional, or alternate, information characterizing these purchase transactions. Further, in some examples, the data records of transaction data 104C may also identify and characterize other types of transaction initiated by, or involving, the customers of the financial institution, such as, but not limited to, bill-payment transactions, electronic funds transfers, currency conversions, purchases or sales of securities, derivatives, or other tradeable instruments, electronic funds transfer (EFT) transactions, or peer-to-peer (P2P) transfers or transactions.

Further, as illustrated in FIG. 1A, internal source system 102B may also be associated with, or operated by, the financial institution, and may maintain, within the corresponding one or more tangible, non-transitory memories, a source data repository 105 that includes one or more elements of collections data 106. In some instances, collections data 106 may include data records that identify and characterize occurrences of prior delinquency events involving customers of the financial institution and corresponding financial products or instruments issued by the financial institution, such as the credit products described herein. By way of example, each of the data records of collections data 106 may associated with a corresponding occurrence of an delinquency event, and may include, for the corresponding occurrence of the delinquency event, a unique identifier of a customer involved in the delinquency event (e.g., an alphanumeric customer identifier, a customer name, etc.), information identifying a financial product or instrument held by the customer and involved in the delinquency event (e.g., a corresponding product type, a corresponding portion of a tokenized account number, etc.), temporal data characterizing of the corresponding occurrence of the delinquency event (e.g., a due date of a missed payment scheduled for an issued credit product, such as a credit-card account, etc.), and additionally, or alternatively, information characterizing a scope of the corresponding occurrence of the delinquency event. Further, the information characterizing the scope of the corresponding occurrence of the delinquency event may specify, among other things, a past-due balance, and a past-due period (e.g., a temporal interval between a current date and the due date of the missed payment).

The data records of collections data 106 may also include, for the corresponding occurrence of the delinquency event, information that identifies each of the remediation processes or treatments implemented by the financial institution to resolve the corresponding occurrence of the delinquency event, and further temporal data that specifies a time or date on which the financial instruction implemented corresponding ones of the remediation processes or treatments. By way of example, the one or more remediation processes or treatments may include, but are not limited to, generating and provisioning, to the corresponding customer, physical or electronic correspondence regarding the corresponding occurrence of the delinquency event (e.g., a physical letter, an email, a text-message, or an in-app notification, etc.), or initiating voice-based communications with the corresponding customer (e.g., via a pre-recorded message delivered by telephone, via a call manually generated by a representative of the financial institution). Further, in some instances, the one or more remediation processes or treatments may also include, among other things, withdrawing funds from one or more accounts of the corresponding customer based on a right of offset maintained by the financial institution, or performing operations that recover all, or a portion, of the past-due balance through interactions with a third-party collections agency. In other instances, and based on any of the customer-, account-, or delinquency-event-specific factors described herein, the one or more remediation processes or treatments may also include a deferral of any treatment of the delinquent customer or the delinquent financial product or instrument.

The disclosed embodiments are, however, not limited to these exemplary elements of customer profile data 104A, account data 104B, and transaction data 104C, or to these exemplary elements of collections data 106. In other instances, the data records of internal interaction data 104 may include any additional or alternate elements of data that identify and characterize the customers of the financial institution and their relationships or interactions with the financial institution, financial products issued to these customers by the financial institution, and transactions involving respective ones of the customers and corresponding ones of the issued financial products or instruments described herein, and the data records of collections data 106 may include any additional, or alternate, information identifying the characterizing the occurrences of the prior delinquency events, and the involved customers and financial products. Further, although stored in FIG. 1A within data repositories maintained by internal source systems 102A and 102B, the exemplary elements of customer profile data 104A, account data 104B, and transaction data 104C, and the exemplary elements of collections data 106, may be maintained by any additional or alternate computing system associated with the financial institution, including, but not limited to, within one or more tangible, non-transitory memories of FI computing system 130.

External source system 102C may be associated with, or operated by, one or more judicial, regulatory, governmental, or reporting entities external to, and unrelated to, the financial institution, and external source system 102C may maintain, within the corresponding one or more tangible, non-transitory memories, a source data repository 107 that includes one or more elements of external interaction data 108. In some instances, external source system 102C may be associated with, or operated by, a reporting entity, such as a credit bureau, and external interaction data 108 may include data records that specify elements of credit-bureau data 108A associated with one or more customers of the financial institution. In some instances, the elements of credit-bureau data 108A for a customer of the financial institution may include, but are not limited to, a unique identifier of the customer (e.g., an alphanumeric identifier or login credential, a customer name, etc.), information identifying one or more financial products or instruments currently or previously held by the customer, information identifying a history of payments associated with these financial products or instruments, information identifying negative events associated with the customer (e.g., missed payments, collections, repossessions, etc.), and/or information identifying one or more credit inquiries involving the customer (e.g., inquiries by the financial institution, other financial institutions or business entities, etc.). The disclosed embodiments are, however, not limited to these exemplary elements of external interaction data 108, and in other instances, external interaction data 108 may include any additional or alternate elements of data associated with the customer and generated by the judicial, regulatory, governmental, or regulatory entities described herein, such as additional, or alternate, elements of credit-bureau data.

In some instances, FI computing system 130 may perform operations that establish and maintain one or more centralized data repositories within a corresponding ones of the tangible, non-transitory memories. For example, as illustrated in FIG. 1A, FI computing system 130 may establish an aggregated data store 132, which maintains, among other things, elements of the customer profile, account, transaction, collections, and credit-bureau data associated with one or more of the customers of the financial institution, which may be ingested by FI computing system 130 (e.g., from one or more of source systems 102) using any of the exemplary processes described herein. Aggregated data store 132 may, for instance, correspond to a data lake, a data warehouse, or another centralized repository established and maintained, respectively, by the distributed components of FI computing system 130, e.g., through a Hadoop™ distributed file system (HDFS).

For example, FI computing system 130 may execute one or more application programs, elements of code, or code modules that, in conjunction with the corresponding communications interface, establish a secure, programmatic channel of communication with each of source systems 102, including internal source system 102A, internal source system 1026, and external source system 102C, across network 120, and may perform operations that access and obtain all, or a selected portion, of the elements of customer profile, account, transaction, collections, and/or reporting data maintained by corresponding ones of source systems 102. As illustrated in FIG. 1A, internal source system 102A may perform operations that obtain all, or a selected portion, of internal interaction data 104, including the data records of customer profile data 104A, account data 104B, and transaction data 104C, from source data repository 103, and transmit the obtained portions of internal interaction data 104 across network 120 to FI computing system 130. Further, internal source system 102B may also perform operations that obtain all, or a selected portion, of collections data 106 from source data repository 105, and transmit the obtained portions of collections data 106 across network 120 to FI computing system 130. Additionally, in some instances, external source system 102C may also perform operations that obtain all, or a selected portion, of external interaction data 108, including the data records of credit-bureau data 108A, from source data repository 107, and transmit the obtained portions of external interaction data 108 across network 120 to FI computing system 130.

In some instances, and prior to transmission across network 120 to FI computing system 130, internal source system 102A, internal source system 102B, and external source system 102C may encrypt respective portions of internal interaction data 104 (including the data records of customer profile data 104A, account data 104B, and transaction data 104C), collections data 106, and external interaction data 108 (including the data records of credit-bureau data 108A) using a corresponding encryption key, such as, but not limited to, a corresponding public cryptographic key associated with FI computing system 130. Further, although not illustrated in FIG. 1A, each of source systems 102 may perform any of the exemplary processes described herein to obtain, encrypt, and transmit additional, or alternate, portions of the locally maintained customer profile, account, transaction, collections, or credit-bureau data maintained across network 120 to FI computing system 130.

A programmatic interface established and maintained by FI computing system 130, such as application programming interface (API) 134, may receive the portions of internal interaction data 104 (including the data records of customer profile data 104A, account data 104B, and transaction data 104C) from internal source system 102A, collections data 106 from internal source system 102B, and external interaction data 108 (including the data records of credit-bureau data 108A) from external source system 102C. As illustrated in FIG. 1A, API 134 may route the portions of internal interaction data 104 (including the data records of customer profile data 104A, account data 1046, and transaction data 104C), collections data 106, and external interaction data 108 (including the data records of credit-bureau data 108A) to a data ingestion engine 136 executed by the one or more processors of FI computing system 130. As described herein, the portions of internal interaction data 104, collections data 106, and external customer data 116 (and the additional, or alternate, portions of the customer profile, account, transaction, collections, or reporting data) may be encrypted, and executed data ingestion engine 136 may perform operations that decrypt each of the encrypted portions of internal interaction data 104, collections data 106, and external customer data 116 (and the additional, or alternate, portions of the customer profile, account, transaction, collections, or reporting data) using a corresponding decryption key, e.g., a private cryptographic key associated with FI computing system 130.

Executed data ingestion engine 136 may also perform operations that store the portions of internal interaction data 104 (including the data records of customer profile data 104A, account data 104B, and transaction data 104C), collections data 106, and external interaction data 108 (including the data records of credit-bureau data 108A) within aggregated data store 132, e.g., as ingested customer data 138. As illustrated in FIG. 1A, a pre-processing engine 140 executed by the one or more processors of FI computing system 130 may access the elements of ingested customer data 138, and perform any of the exemplary data-processing operations described herein to preprocess the accessed elements of ingested customer data 138 and to generate consolidated data records 142 that characterize corresponding ones of the customers, their interactions with the financial institution and with other financial institutions, and any associated delinquency events during a temporal interval associated with the ingestion of internal interaction data 104, collections data 106, and external interaction data 108 by executed data ingestion engine 136.

By way of example, executed pre-processing engine 140 may access the data records of customer profile data 104A, account data 104B, transaction data 104C, collections data 106, and/or credit-bureau data 108A, e.g., as maintained within ingested customer data 138). As described herein, each of the accessed data records may include an identifier of corresponding customer of the financial institution, such as a customer name or an alphanumeric character string, and executed pre-processing engine 140 may perform operations that map each of the accessed data records to a customer identifier assigned to the corresponding customer by FI computing system 130. By way of example, FI computing system 130 may assign a unique, alphanumeric customer identifier to each customer, and executed pre-processing engine 140 may perform operations that parse the accessed data records, identify each of the parsed data records that identifies the corresponding customer using a customer name, and replace that customer name with the corresponding alphanumeric customer identifier.

Executed pre-processing engine 140 may also perform operations that assign a temporal identifier to each of the accessed data records, and that augment each of the accessed data records to include the newly assigned temporal identifier. In some instances, the temporal identifier may associate each of the accessed data records with a corresponding temporal interval, which may be indicative of reflect a regularity or a frequency at which FI computing system 130 ingests the elements of internal interaction data 104, collections data 106, and external interaction data 108. For example, executed data ingestion engine 136 may receive elements of confidential customer data from corresponding ones of source systems 102 on a monthly basis (e.g., on the final day of the month), and in particular, may receive and store the elements of internal interaction data 104, collections data 106, and external interaction data 108 from corresponding ones of source systems 102 on May 31, 2021. Executed pre-processing engine 140 may generate a temporal identifier associated with the regular, monthly ingestion of internal interaction data 104, collections data 106, and external interaction data 108 on May 31, 2021 (e.g., “2021-05-31”), and may augment the accessed data records of customer profile data 104A, account data 104B, transaction data 104C, collections data 106, and/or credit-bureau data 108A to include the generated temporal identifier. The disclosed embodiments are, however, not limited to temporal identifiers reflective of a monthly ingestion of internal interaction data 104, collections data 106, and external interaction data 108 by FI computing system 130, and in other instances, executed pre-processing engine 140 may augment the accessed data records to include temporal identifiers reflective of any additional, or alternative, temporal interval during which FI computing system 130 ingests the elements of internal interaction data 104, collections data 106, and external interaction data 108.

In some instances, executed pre-processing engine 140 may perform further operations that, for a particular customer of the financial institution during the temporal interval (e.g., represented by a pair of the customer and temporal identifiers described herein), obtain one or more data records of customer profile data 104A, account data 104B, transaction data 104C, collections data 106, and credit-bureau data 108A that include the pair of customer and temporal identifiers. Executed pre-processing engine 140 may perform operations that consolidate the one or more obtained data records and generate a corresponding one of consolidated data records 142 that includes the customer identifier and temporal identifier, and that is associated with, and characterizes, the particular customer of the financial institution across the temporal interval. By way of example, executed pre-processing engine 140 may consolidate the obtained data records, which include the pair of customer and temporal identifiers, through an invocation of an appropriate Java-based SQL “join” command (e.g., an appropriate “inner” or “outer” join command, etc.). Further, executed pre-processing engine 140 may perform any of the exemplary processes described herein to generate another one of consolidated data records 142 for each additional, or alternate, customer of the financial institution during the temporal interval (e.g., as represented by a corresponding customer identifier and the temporal interval). In some instances, executed pre-processing engine 140 may perform operations that store each of consolidated data records 142 within one or more tangible, non-transitory memories of FI computing system 130, such as consolidated data store 144. Consolidated data store 144 may, for example, correspond to a data lake, a data warehouse, or another centralized repository established and maintained, respectively, by the distributed components of FI computing system 130, e.g., through a Hadoop™ distributed file system (HDFS).

In some instances, and as described herein, consolidated data records 142 may include a plurality of discrete data records, each of these discrete data records may be associated with, and may maintain data characterizing, a corresponding one of the customers of the financial institution during the corresponding temporal interval (e.g., a month-long interval extending from May 1, 2021, to May 31, 2021). By way of example, and for a particular customer of the financial institution, discrete data record 142A of consolidated data records 142 may include a customer identifier 146 of the particular customer (e.g., an alphanumeric character string “CUSTID”), a temporal identifier 148 of a corresponding temporal interval (e.g., a numerical string “2021-05-31”), and elements 150 of consolidated data that identify and characterize the particular customer during the corresponding temporal interval. For instance, consolidated data elements 150 may include, among other things, one or more of the data records of customer profile data 104A, account data 104B, transaction data 104C, collections data 106, and/or credit-bureau data 108A associated with the particular customer and ingested by FI computing system 130 on May 31, 2021.

Referring to FIG. 1B, a filtration engine 152 executed by the one or more processors of FI computing system 130 may access each of the data records of consolidated data records 142 maintained within consolidated data store 144 (e.g., data record 142A, as described herein), and perform operations that filter the accessed data records of consolidated data records 142 in accordance with one or more filtration criteria. Executed filtration engine 152 may, for example, determine that a subset of the data records of consolidated data records 142 are consistent with, and in compliance with, the one or more filtration criteria, and may perform operations that stored the filtered subset of the data records within a corresponding portion of consolidated data store 144, e.g., as filtered data records 154.

In some instances, the one or more filtration criteria may include a product-specific filtration criterion that, when processed by executed filtration engine 152, causes executed filtration engine 152 may to exclude, from filtered data records 154, one or more of consolidated data records 142 identifying and characterizing a corresponding customer that fails to hold one of the credit products described herein during the corresponding temporal interval. Additionally, or alternatively, the one or more filtration criteria may include a collections-specific filtration criterion that, when processed by executed filtration engine 152, causes executed filtration engine 152 to exclude, from filtered data records 154, one or more of consolidated data records 142 identifying and characterizing a corresponding customer of the financial institution that fails to be involved in an unresolved delinquency event associated with one of the credit products described herein during the corresponding temporal intervals. The disclosed embodiments are, however, not limited to these exemplary product- and collections-specific filtration criteria, and in other instances, executed filtration engine 152 may apply any additional or alternate filtration criterion to the data records of consolidated data records 142 that would be appropriate to the customers of the financial institution, the financial institution, and consolidated data records 142, and that facilitate an adaptive training and validation of the exemplary machine-learning or artificial intelligence processes described herein.

For example, as illustrated in FIG. 1B, executed filtration engine 152 may access discrete data record 142A of consolidated records 142A, which includes customer identifier 146 of the particular customer (e.g., an alphanumeric character string “CUSTID”), temporal identifier 148 of the corresponding temporal interval (e.g., a numerical string “2021-05-31”), and consolidated data elements 150 that identify and characterize the particular customer during the corresponding temporal interval. In some instances, executed filtration engine 152 may perform operations that parse consolidated data elements 150 and obtain information that identifies a product type associated with each of the financial products or instruments issued by the financial institution and held by the particular customer during the corresponding temporal interval. Based on the application of the product-specific filtration criterion described herein to the information identifying the products types, executed filtration engine 152 may establish that the particular customer holds one of the credit products issued by the financial institution, and may establish that data record 142A satisfies the product-specific filtration criterion.

In response to the established satisfaction of the product-specific filtration criterion, executed filtration engine 152 may perform operations that store data record 142A within an additional portion of consolidated data 144, e.g., as one or filtered data records 154, which may be suitable for training adaptively the gradient-boosted, decision-tree process described herein. Further, as illustrated in FIG. 1A, executed filtration engine 152 may perform operations that augment data record 142A within filtered data records 154 to include data, such as product-specific flag 156A, confirming that the particular customer holds the credit product issued by the financial institution during the corresponding temporal interval and as such, that data record 142A satisfies the product-specific filtration criterion.

Further, and in addition to, or as an alternate to, the application of the product-specific filtration criterion to consolidated data records 142, executed filtration engine 152 may perform operations that apply a collections-specific filtration criterion to one or more of the data records of consolidated data records 142. As illustrated in FIG. 1A, executed filtration engine 152 may access discrete data record 142A of consolidated records 142A, and may perform operations that parse consolidated data elements 150 and obtain data indicative of an occurrence (or a non-occurrence) of a delinquency events involving the particular customer during the corresponding temporal intervals. By way of example, the data indicative of the occurrence, or non-occurrence, of the delinquency event involving the particular customer may include, but is not limited to, an identifier of a credit product held by the particular customer and involved in the delinquency event (e.g., a corresponding product type, etc.), temporal data characterizing of the occurrence of the delinquency event (e.g., a due date of a missed payment scheduled for the credit product, such as a credit-card account, etc.), and information characterizing a scope of the occurrence of the delinquency event, such as a past-due amount or a past-due period (e.g., a number of days since the missed payment, etc.).

Executed filtration engine 152 may apply the collections-specific filtration criterion to the obtained data indicative of the occurrence of the delinquency event, and may determine that the particular customer was involved in a delinquency event involving an issued credit product that either: (i) occurred during the corresponding temporal interval, e.g., the due date of the missed payment falls within the month-long interval extending from May 1, 2021, to May 31, 2021; or (ii) remained pending during at least a portion of the corresponding temporal interval (e.g., the missed payment for the credit product remains past-due during at least a portion of the month-long interval extending from May 1, 2021, to May 31, 2021). Based on the determination that the particular customer was involved in the delinquency event involving the credit product that either occurred or remained pending during the corresponding temporal interval, executed filtration engine 152 may establish that data record 142A satisfies the collections-specific filtration criterion, and may perform operations that store data record 142A within the additional portion of consolidated data 144, e.g., as one of filtered data records 154. Further, as illustrated in FIG. 1A, executed filtration engine 152 may perform operations that augment data record 142A within filtered data records 154 to include data, such as collections-specific flag 156B, confirming that the particular customer was involved in the delinquency event involving the credit product that either occurred during or extended through the corresponding temporal interval and as such, that data record 142A satisfies the product-specific filtration criterion.

In some instances, not illustrated in FIG. 1B, executed filtration engine 152 may establish that data record 142A fails to satisfy the product-specific filtration criterion and additionally, or alternatively, the collections-specific filtration criteria. For example, in applying the product-specific filtration criterion to data record 142A, executed filtration engine 152 may determine that the particular customer fails to hold a credit product issued by the financial institution during the corresponding temporal interval and as such, may establish that data record 142A is inconsistent with the product-specific filtration criterion. Additionally, or alternatively, in applying the collections-specific filtration criterion to data record 142A, executed filtration engine 152 may determine that the particular customer is not involved in a delinquency event involving a credit product that either occurred during or extended through the corresponding temporal interval and as such, may establish that data record 142A is inconsistent with the collection-specific filtration criterion. Based on the established inconsistency between data record 142A and the product-specific filtration criterion and/or the collections-specific filtration criterion, executed filtration engine 152 may determine that data record 142A is unsuitable for adaptively training and validating the machine-learning or artificial intelligence process described herein, and may decline to store data record 142A within the additional portion of consolidated data store 144 associated with filtered data records 154.

Further, executed filtration engine 152 may access each of the additional data records of consolidated data records 142, and may perform any of the exemplary processes described herein to establish a consistency, or an inconsistency, between each of the additional data records and the product-specific filtration criterion, the collection-specific filtration criterion, and any additional, or alternate, filtration criterion. Based on the established consistency with all, or a selected subset, or these filtration criteria, executed filtration engine 152 may perform operations that store corresponding ones of the additional data records within filtered data records 154, e.g., in conjunction with a corresponding flag confirming the established satisfaction of the product-specific, collections-specific, or other filtration criterion. Alternatively, based on the established in consistency with one or more of these filtration criteria, executed filtration engine 152 may deem the corresponding ones of the additional data records unsuitable for adaptively training and validating the machine-learning or artificial intelligence, and may decline to store these additional data records within the portion of consolidated data store 144 associated with filtered data records 154 (not illustrated in FIG. 1B).

Referring back to FIG. 1B, an aggregation engine 158 executed by the one or more processors of FI computing system 130 may access each of the data records of filtered data records 154. As described herein, each of the accessed data records may include corresponding elements of consolidated data that identify and characterize a particular customer of the financial institution during a corresponding temporal interval (e.g., the data records of customer profile data 104A, account data 104B, transaction data 104C, collections data 106, and/or credit-bureau data 108A associated with the particular customer and ingested by FI computing system 130). Further, and for each of the accessed data records, executed aggregation engine 158 may perform operations that process the corresponding elements of consolidated data and generate elements of aggregated account data that characterize a usage of one or more financial products or instruments during the corresponding temporal interval, and elements of aggregated transaction data characterizing a spending or purchasing habit of the particular customer during the corresponding temporal interval.

By way of example, executed aggregation engine 158 may access data record 142A within filtered data records 154, which includes consolidated data elements 150 that identifies and characterizes a particular customer of the financial institution (e.g., associated with customer identifier 146) during a corresponding temporal interval (e.g., the one-month interval between May 1, 2021, and May 31, 2021, as specified by temporal identifier 148). Executed aggregation engine 158 may also perform operations that obtain, from consolidated data elements 150, elements of account data that identify and characterize the interactions between the particular customer and the one or more financial products or instruments issued by the financial institution during the corresponding temporal interval (e.g., one or more data records of account data 104B ingested by FI computing system 130), and elements of transaction data that identify and characterize one or more transactions initiated by the particular customer during the corresponding temporal interval (e.g., one or more data records of transaction data 104C ingested by FI computing system 130).

In some instances, executed aggregation engine 158 may perform operations that generate one or more elements of aggregated account data 160 based on corresponding portions of the obtained account data elements, and that generate one or more elements of aggregated transaction data 162 based on corresponding portions of the obtained transaction data elements. For example, the elements of aggregated account data 160 may include, but are not limited to, an average of a total balance across one or more credit products held by the customer associated with customer identifier 146 during the temporal interval associated with temporal identifier 148 (e.g., an average balance across a credit-card account, a line-of-credit, a personal loan, etc.), an average of a total amount of credit extended to the customer during the temporal interval, or an average balance of funds available to the customer within one or more demand deposit accounts during the corresponding temporal interval. In some examples, the elements of aggregated transaction data 162 may include, but are not limited to, a total transaction amount attributable to one or more types of transactions initiated by the customer during the temporal interval, such as, but not limited to, purchase transactions, peer-to-peer transactions, payroll deposits, bill-payment transactions, real-time payment transactions, or electronic funds transfers (EFT) transactions.

Further, and by way of example, the elements of aggregated transaction data 162 may include values of aggregated transaction parameters that characterize a particular type or class of transaction, such as purchase transactions initiated by the customer associated with customer identifier 146 during the temporal interval associated with temporal identifier 148. For instance, the elements of aggregated transaction data 162 may include, among other things, a total transaction amount attributable to the initiated purchase transactions involving certain categories of merchants (e.g., based on corresponding SIC codes or MCCs maintained with the obtained transaction data elements, etc.), a total transaction amount attributable to the initiated purchase transactions involving certain purchased products or services, or a total transaction amount attributable to the initiated purchase transactions involving certain processing networks, such as, but not limited to, conventional payment rails or real-time payment rails. The disclosed embodiments are, however, not limited to these exemplary elements of aggregated account or transaction data, and in other instances, executed aggregation engine 158 may process filtered data records 154 and generate any additional, or alternate, elements of aggregated account data 160 that characterize the usage of the financial products or instruments held by the particular customer during the temporal interval, and any additional, or alternate, elements of aggregated transaction data 162 characterizing a spending or purchasing habit of the customer during the temporal interval.

In some instances, executed aggregation engine 158 may perform operations that augment the accessed data record 142A (e.g., as maintained within a portion of consolidated data store 144 associated with filtered data records 154) to include the elements of aggregated account data 160 and the elements of aggregated transaction data 162. Further, although not illustrated in FIG. 1B, executed aggregation engine 158 may also perform any of the exemplary processes described herein to access each additional, or alternate, data record of filtered data records 154, to generate one or more elements of aggregated account and transaction data associated with a corresponding one of the customers during a corresponding temporal interval, and to augment each of the additional, or alternate, data records to include respective ones of the generate elements of aggregated account and transaction data.

Further, as illustrated in FIG. 1B consolidated data store 144 may maintain each of filtered data records 154 in conjunction with additional filtered data records 164. In some instances, executed preprocessing engine 140, executed filtration engine 152, and executed aggregation engine 158 may perform any of the exemplary processes described herein, either individually or collectively, to generate each of the additional filtered data records 164 based on elements of profile, account, transaction, insolvency, and credit-bureau data ingested from source systems 102 during the corresponding prior temporal intervals.

In some instances, each of additional filtered data records 164 may include a plurality of discrete data records that are associated with and characterize a particular one of the customers of the financial institution during a corresponding one of the prior temporal intervals. For example, additional filtered data records 164 may include one or more discrete data records, such as discrete data record 165, associated with a prior temporal interval extending from Apr. 1, 2021, to Apr. 30, 2021. For the particular customer, discrete data record 165 may include a customer identifier 166 of the particular customer (e.g., an alphanumeric character string “CUSTID”), a temporal identifier 167 of the prior temporal interval (e.g., a numerical string “2021-04-30”), and consolidated elements 168 of customer profile, account, transaction, insolvency, or credit-bureau data that characterize the particular customer during the prior temporal interval extending from Apr. 1, 2021, to Apr. 30, 2021 (e.g., as consolidated from the data records ingested by FI computing system 130 on Apr. 30, 2021).

As illustrated in FIG. 1B, discrete data record 165 may also include one or more data flags indicative of an established consistency of discrete data record 165 with one or more filtration criteria, such as, but not limited to, a product-specific flag 169A indicative of an established consistency between data record 165 and the product-specific filtering criterion described herein, and a collections-specific flag 169B indicative of an established consistency between data record 165 and the collections-specific filtering criterion described herein. Further, discrete data record 165 may include one or more elements of aggregated account data 170 that characterize the usage of the financial products or instruments held by the particular customer during the prior temporal interval, and one or more elements of aggregated transaction data 171 characterizing a spending or purchasing habit of the particular customer during the prior temporal interval. In some instances, each of the additional, or alternate, data records of filtered data records 164 may include and maintain a customer identifier, temporal identifier, consolidated data elements, data flags, and elements of aggregated account or transaction data, which may be similar in structure and composition to those described above in reference to data record 165.

The disclosed embodiments are, however, not limited to the exemplary consolidated or filtered data records described herein, or to the exemplary temporal intervals described herein. In other examples, FI computing system 130 may generate, and the consolidated data store 144 may maintain, any additional or alternate number of discrete sets of filtered data records, having any additional or alternate composition, that would be appropriate to the elements of customer profile, account, transaction, collections, or credit-bureau data ingested by FI computing system 130 at the predetermined intervals described herein. Further, in some examples, FI computing system 130 may ingest elements of customer profile, account, transaction, collections, or credit-bureau data from source systems 102 at any additional, or alternate, fixed or variable temporal interval that would be appropriate to the ingested data.

In some instances, FI computing system 130 may perform any of the exemplary operations described herein to adaptively train, using training datasets associated with a first prior temporal interval (e.g., a “training” interval),and using validation datasets associated with a second, and distinct, prior temporal interval (e.g., an out-of-time “validation” interval, a machine-learning or artificial-intelligence process to predict a likelihood of an occurrence of a default event involving a customer of the financial institution and a credit product within a predetermined time period subsequent to an occurrence of a delinquency event involving that customer and credit product. As described herein, examples of the credit product may include, but are not limited to, as a credit-card account, a home mortgage, an auto loan, an unsecured personal loan, a secured or unsecured line-of-credit, and/or an overdraft protection (ODP) product. Further, and by way of example, the delinquency event involving the customer of the financial institution and the credit product issued by that financial institution may occur when the customer fails to submit a scheduled payment associated with the credit product (e.g., when that scheduled payment becomes “past due”), and the default event involving the customer and the credit product may occur when the scheduled payment remains past due for a past-due period, such as, but not limited to, ninety calendar days.

In some examples, the machine-learning or artificial-intelligence process may include an ensemble or decision-tree process, such as a gradient-boosted decision-tree process (e.g., the XGBoost model), and the training and validation datasets may include, but are not limited to, values of adaptively selected features obtained, extracted, or derived from the filtered data records maintained within consolidated data store 144, e.g., from data elements maintained within the discrete data records of filtered data records 154 or the additional filtered data records 164. As described herein, each of the discrete data records of filtered data records 154 and the additional filtered data records 164 (e.g., data record 142A, data record 165, etc.) may be associated with a corresponding customer of the financial institution involved in a delinquency event that occurred during, or extended through and remained pendant during at least a portion of, a corresponding temporal interval associated with the discrete data records, and each of the discrete data records may include additional elements of consolidated data, aggregate account data, and/or aggregate transaction data that identify and characterize the corresponding customer, the interactions between the corresponding customer and the financial institution, and the delinquency event during the corresponding temporal interval.

Further, and by way of example, the distributed computing components of FI computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes. Based on an outcome of these adaptive training processes, FI computing system 130 may generate model coefficients, parameters, thresholds, and other modelling data that collectively specify the trained machine learning or artificial intelligence process, and may store the generated model coefficients, parameters, thresholds, and modelling data within a portion of the one or more tangible, non-transitory memories, e.g., within consolidated data store 144.

Referring to FIG. 1C, a training engine 172 executed by the one or more processors of FI computing system 130 may access the filtered data records maintained within consolidated data store 144, such as, but not limited to, filtered data records 154 or additional filtered data records 164. As described herein, each of the filtered data records, such as discrete data record 142A of filtered data records 154 or discrete data record 165 of additional filtered data records 164, may include a customer identifier of a corresponding one of the customers of the financial institution (e.g., customer identifiers 146 and 166 of FIG. 1B) and a temporal identifier that associates the filtered data record with a corresponding temporal interval (e.g., temporal identifiers 148 and 167 of FIG. 1B). Further, as described herein, each of the filtered data records may include consolidated elements of customer profile, account, transaction, collections, or credit-bureau data that characterize the corresponding one of the customers during the corresponding temporal interval (e.g., consolidated data elements 150 and 168 of FIG. 1B), elements of aggregated account data that characterize interactions between the corresponding one of the customers and issued financial products or instruments during the corresponding temporal interval (e.g., aggregated account data elements 160 and 170 of FIG. 1B), and elements of aggregated transaction data characterizing a purchasing or spending behavior of the corresponding one of the customers during the corresponding temporal interval (e.g., aggregated transaction data elements 162 and 171 of FIG. 1B). Each of the filtered data records may also satisfy one or more filtration criteria, such as, but not limited to, the product- and collections-specific filtration criteria described herein, and may also include a data flag indicative of the consistency with corresponding ones of the product- and collections-specific filtration criteria (e.g., product-specific flags 156A and 169A, collections-specific flags 156B, and 169B of FIG. 1B, etc.).

In some instances, executed training engine 172 may parse the filtered data records, and based on corresponding ones of the temporal identifiers, determine that the consolidated elements of customer profile, account, transaction, collections, or credit-bureau data characterize the corresponding customers across a range of prior temporal intervals. Further, executed training engine 172 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 1D, the range of prior temporal intervals (e.g., shown generally as Δt along timeline 173 of FIG. 1D) may be bounded by, and established by, temporal boundaries tᵢ and t_{f}. Further, the decomposed first subset of the prior temporal intervals (e.g., shown generally as training interval Δt_{training} along timeline 173 of FIG. 1D) may be bounded by temporal boundary tᵢ and a corresponding splitting point tₛₚₗᵢₜ along timeline 173, and the decomposed second subset of the prior temporal intervals (e.g., shown generally as validation interval Δt_{validation} along timeline 173 of FIG. 1D) may be bounded by splitting point tₛₚₗᵢₜ and temporal boundary t_{f}.

Referring back to FIG. 1C, executed training engine 172 may generate elements of splitting data 174 that identify and characterize the determined temporal boundaries (e.g., temporal boundaries tᵢ and t_{f}) and the range of prior temporal intervals established by the determined temporal boundaries The elements of splitting data 174 may also identify and characterize the splitting point (e.g., the splitting point tₛₚₗᵢₜ described herein), the first subset of the prior temporal intervals (e.g., the training interval Δt_{training} described herein), and the second, and subsequent subset of the prior temporal intervals (e.g., the validation interval Δt_{validation} described herein). As illustrated in FIG. 1C, executed training engine 172 may store the elements of splitting data 174 within the one or more tangible, non-transitory memories of FI computing system 130, e.g., within consolidated data store 144.

In some instances, each of the prior temporal intervals may correspond to a one-month interval, and executed training engine 172 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. By way of example, executed training engine 172 may compute one or both of the first and second predetermined percentages, and establish the splitting point, based on the range of prior temporal intervals, a quantity or quality of the consolidated data records maintained within consolidated data store 144, or a magnitude of the temporal intervals (e.g., one-month intervals, two-week intervals, one-week intervals, one-day intervals, etc.).

In some examples, a training input module 176 of executed training engine 172 may perform operations that access the filtered data records maintained within consolidated data store 144. As described herein, each of the accessed data records (e.g., the discrete data records within filtered data records 154 or additional filtered data records 164) may identify and characterize a customer of the financial institution (e.g., identified by a corresponding customer identifier) during a temporal interval (e.g., associated with a corresponding temporal identifier), interactions of the customer with the financial institution and with other financial institutions during the temporal interval, and a delinquency event involving the customer and a corresponding credit product that occurred or remained during at least a portion of the temporal interval. In some instances, and based on portions of splitting data 174, executed training input module 176 may perform operations that parse the filtered data records and determine: (i) a first subset 178A of these consolidated data records are associated with the training interval Δt_{training} and may be appropriate to training adaptively the gradient-boosted decision model during the training interval; and a (ii) second subset 178B of these consolidated data records are associated with the validation interval Δt_{validation} and may be appropriate to validating the adaptively trained gradient-boosted decision model during the validation interval.

Prior to partitioning the filtered data records maintained within consolidated data store 144 into corresponding ones of first subset 178A and second subset 178B, executed training input module 176 may perform operations that augment each of the filtered data records (e.g., filtered data records 154 and 164, etc.) to include additional information characterizing a ground truth associated with the corresponding customer and temporal interval (as established by the corresponding pair of customer and temporal identifiers). For example, and for a particular one of the filtered data records, such as discrete data record 142A of filtered data records 154, executed training input module 176 may obtain customer identifier 146 (e.g., “CUSTID”), which identifies the corresponding customer, and may obtain temporal identifier 148, which indicates data record 142A is associated with an ingestion date of May 31, 2021. As described herein, consolidated data elements 150 of discrete data record 142A may include elements of consolidated collections data, which may specify, among other things, that the corresponding customer is involved in a delinquency event associated with a credit product, such as a credit-card account issued by the financial institution. The elements of consolidated collections data maintained within consolidated data elements 150 may also specify that a temporal initiation point for delinquency event corresponds May 11, 2021, and that a current past-due period associated with the delinquency event corresponds to twenty calendar days, and that the delinquency event is associated with a past-due balance of $1,475.00.

Further, and based on customer identifier 146 and temporal identifier 148, executed training input module 176 may access aggregated data store 132, and obtain additional elements of collections data ingested by the FI computing system subsequent to the May 31, 2021. In some instances, and based on the additional elements of collections data, executed training input module 176 determine whether the past-due period of the delinquency event exceeds, or becomes equivalent to, the threshold, past-due temporal interval (e.g., the predetermined time period of ninety calendar days, as described herein) within a target temporal interval (e.g., the predetermined time period of 119 calendar days, as described herein) subsequent to the May 31^{st} initiation date of the delinquency event, and as such, whether the corresponding customer is associated with an occurrence, or non-occurrence, of a default event involving the credit-card account within the target temporal interval subsequent to the May 31^{st} initiation date of the delinquency event. Executed training input module 176 may perform operations that modify data record 142A by appending an element of ground-truth data indicative of the occurrence or non-occurrence of the default event to data record 142A. Executed training input module 176 may also perform any of the exemplary processes described herein to generate and append an appropriate element of ground-truth data to each additional, or alternate, one of the sequentially ordered data records within each of the customer-specific sets of filtered data records maintained within consolidated data store 144.

Executed training input module 176 may also perform operations that partition the customer-specific sets of sequentially ordered data records into subsets suitable for training adaptively the gradient-boosted, decision-tree process (e.g., which may be maintained in first subset 178A of filtered data records within consolidated data store 144) and for validating the adaptively trained, gradient-boosted, decision-tree process (e.g., which may be maintained in second subset 168B of filtered data records within consolidated data store 144). By way of example, executed training input module 176 may access splitting data 174, and establish the temporal boundaries for the training interval Δt_{training} (e.g., temporal boundary tᵢ and splitting point tₛₚₗᵢₜ) and the validation interval Δt_{training} (e.g., splitting point tₛₚₗᵢₜ and temporal boundary t_{f}). Further, executed training input module 176 may also parse each of the sequentially ordered data records of the customer-specific sets, access the corresponding temporal identifier, and determine the temporal interval associated with the each of sequentially ordered data records.

If, for example, executed training input module 176 were to determine that the temporal interval associated with a corresponding one of the sequentially ordered data records is disposed within the temporal boundaries for the training interval Δt_{training}, executed training input module 176 may determine that the corresponding data record may be suitable for training, and may perform operations that include the corresponding data record within a portion of the first subset 178A (e.g., that store the corresponding data record within a portion of consolidated data store 144 associated with first subset 178A). Alternatively, if executed training input module 176 were to determine that the temporal interval associated with a corresponding one of the sequentially ordered data records is disposed within the temporal boundaries for the validation interval Δt_{validation}, executed training input module 176 may determine that the corresponding data record may be suitable for validation, and may perform operations that include the corresponding data record within a portion of the second subset 178B (e.g., that store the corresponding data record within a portion of consolidated data store 144 associated with second subset 178B). Executed training input module 176 may perform any of the exemplary processes described herein to determine the suitability of each additional, or alternate, one of the sequentially ordered data records of the customer-specific sets for adaptive training, or alternatively, validation, of the gradient-boosted, decision-tree process.

Further, in some instances, the filtered data records within first subset 178A and second subset 178B may represent an imbalanced data set in which the actual occurrences of default events within the target temporal interval are outnumbered disproportionately by non-occurrences of default events within the target temporal interval (e.g., as established by the elements of ground-truth data appended for the filtered data records of first subset 178A and second subset 178B, as described herein). Based on the imbalanced character of first subset 178A and second subset 178B, executed training input module 176 may perform operations that downsample the filtered data records within first subset 178A and second subset 178B that are associated with the non-occurrences of default events (e.g., as established by the appended elements of ground-truth data), and the downsampled data records maintained within each first subset 178A and second subset 178B may represent balanced data sets characterized by a more proportionate balance between the occurrences and non-occurrences of the default events within the target temporal interval Δt_{target} subsequent to the temporal initiation point tᵢₙᵢₜ of the corresponding delinquency events.

Referring back to FIG. 1C, executed training input module 176 may perform operations that generate a plurality of training datasets 180 based on elements of data obtained, extracted, or derived from all or a selected portion of first subset 178A of the consolidated data records. By way of example, each of the plurality of training datasets 180 may be associated with a corresponding one of the customers of the financial institution and a corresponding temporal interval, and may include, among other things a customer identifier associated with that corresponding customer and a temporal identifier representative of the corresponding temporal interval within the training interval Δt_{training}, as described herein. In some instances, for each of the plurality of training datasets 180, the corresponding customer may hold a credit product issued by the financial institution, and as described herein, the corresponding customer may be associated with a corresponding delinquency event that involves the issued credit product and that is initiated or remains pending during the corresponding temporal interval.

Each of the plurality of training datasets 180 may also include elements of data (e.g., feature values) that characterize the corresponding one of the customers and the corresponding customer's interaction with the financial institution, with other financial institution, and with financial products and instruments issued by the financial institution, such as, but not limited to the credit products described herein. Further, each of training datasets 180 may also include an element of ground-truth data indicative of occurrence, or non-occurrence, of a default event involving the corresponding customer and the credit product within the target temporal interval (e.g., the predetermined, 119-day period described herein) subsequent to the occurrence of the corresponding delinquency event.

In some instances, executed training input module 176 may perform operations that identify, and obtain or extract, one or more of the features values from the filtered data records maintained within first subset 178A and associated with the corresponding one of the customers. For example, the obtained or extracted feature values may include elements of the customer profile, account, transaction, collections, or credit-bureau data described herein, along with elements of aggregated account or transaction data, which may populate collectively the filtered data records maintained within first subset 178A. Examples of these obtained or extracted feature values may include, but are not limited to: data identifying one or more types of financial products held by the corresponding ones of the customers, e.g., such as one or more of the credit products described herein; time-averaged balances of one or more credit products held by the corresponding ones of the customers; time-averaged sums of these balances; time-average values of purchase transactions initiated by corresponding ones of the customers on across one or more merchant or retailer categories, or that involving one or more types of products or services; or a number of credit inquiries involving the corresponding one of the customers. The disclosed embodiments are, however, not limited to these obtained or extracted feature values, and in other instances, training datasets 180 may include any additional or alternate element of data extracted or obtained from the filtered data records of first subset 178A and associated with corresponding one of the customers.

Further, in some instances, executed training input module 176 may perform operations that compute, determine, or derive one or more of the features values based on elements of data extracted or obtained from the filtered data records maintained within first subset 178A. Examples of these computed, determined, or derived feature values may include, but are not limited to: a computed temporal interval during which corresponding ones of the customers reside at a current mailing address; aggregated values characterizing relationships between the financial institution and corresponding ones of the customers; a total number of secured or unsecured credit products held by corresponding ones of the customers; or total numbers of past-due balances or delinquencies associated with corresponding ones of the customers. The disclosed embodiments are, however, not limited to these computed, determined, or derived feature values, and in other instances, training datasets 180 may include any additional or alternate features computed, determine, or derived from data extracted or obtained from the filtered data records of first subset 178A associated with corresponding one of the customers.

Executed training input module 176 may provide training datasets 180 as an input to an adaptive training and validation module 182 of executed training engine 172. In some instances, and upon execution by the one or more processors of FI computing system 130, adaptive training and validation module 182 may perform operations that establish a plurality of nodes and a plurality of decision trees for the gradient-boosted, decision-tree process, with may ingest and process the elements of training data (e.g., the customer identifiers, the temporal identifiers, the feature values, etc.) maintained within each of the plurality of training datasets 180. Based on the execution of adaptive training and validation module 182, and on the ingestion of each of training datasets 180 by the established nodes of the gradient-boosted, decision-tree process, FI computing system 130 may perform operations that adaptively train the gradient-boosted, decision-tree process against the elements of training data included within each of training datasets 180.

In some examples, the distributed components of FI computing system 130 may execute adaptive training and validation module 182, and may perform any of the exemplary processes described herein in parallel to train adaptively the gradient-boosted, decision-tree process against the elements of training data included within each of training datasets 180. The parallel implementation of adaptive training and validation module 182 by the distributed components of FI computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

Further, and as described herein, executed adaptive training and validation module 182 may perform operations that adaptively train the gradient-boosted, decision-tree process described herein to predict, at any temporal point during a pendency of a delinquency event involving a corresponding customer and credit product, a likelihood of an occurrence of a default event involving the customer and the credit product within the target temporal interval subsequent to the occurrence of the delinquency event. The delinquency event may, for example, occur when the corresponding customer fails to submit a scheduled payment associated with the corresponding credit product (e.g., when that scheduled payment becomes “past due”), and referring to FIG. 1E, the occurrence (or initiation) of the delinquency event may be characterized by a temporal initiation point tᵢₙᵢₜ along timeline 179. Further, the target temporal interval, illustrated as Δt_{target} in FIG. 1E, may be characterized by a corresponding, predetermined time period disposed subsequent to a temporal initiation point tᵢₙᵢₜ along timeline 179, such as, but not limited to, a predetermined time period of 119 calendar days, and the target temporal interval Δt_{target} may be bounded by the temporal initiation point tᵢₙᵢₜ and a corresponding target temporal point t_{target} (e.g., the closed interval [tᵢₙᵢₜ, t_{target}], where t_{target}=tᵢₙᵢₜ+Δt_{target}). Further, the default event involving the corresponding customer and credit product may occur when a past-due interval associated with the missed payment, illustrated as Δt_{past-due} in FIG. 1E, exceeds a threshold temporal interval, such as, but not limited to, a predetermined time period of ninety calendar days. For example, the past-due interval Δt_{past-due} in FIG. 1E may be characterized by a corresponding, predetermined time period disposed subsequent to a temporal initiation point tᵢₙᵢₜ along timeline 179.

Referring back to FIG. 1C, and through the performance of these adaptive training processes, executed adaptive training and validation module 182 may perform operations that compute one or more candidate model parameters that characterize the adaptively trained, gradient-boosted, decision-tree process, and package the candidate model parameters into corresponding portions of candidate model data 184. In some instances, the candidate model parameters included within candidate model data 184 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, executed adaptive training and validation module 182 may also generate candidate input data 186, which specifies a candidate composition of an input dataset for the adaptively trained, gradient-boosted, decision-tree process (e.g., which be provisioned as inputs to the nodes of the decision trees of the adaptively trained, gradient-boosted, decision-tree process).

As illustrated in FIG. 1C, executed adaptive training and validation module 182 may provide candidate model data 184 and candidate input data 186 as inputs to executed training input module 176 of training engine 172, which may perform any of them exemplary processes described herein to generate a plurality of validation datasets 188 having compositions consistent with candidate input data 186. As described herein, the plurality of validation datasets 188 may, when provisioned to, and ingested by, the nodes of the decision trees of the adaptively trained, gradient-boosted, decision-tree process, enable executed training engine 172 to validate the predictive capability and accuracy of the adaptively trained, gradient-boosted, decision-tree process, for example, based on elements of ground truth data incorporated within the validation datasets 188, or based on one or more computed metrics, such as, but not limited to, computed precision values, computed recall values, and computed area under curve (AUC) for receiver operating characteristic (ROC) curves or precision-recall (PR) curves.

By way of example, each of the plurality of validation datasets 188 may be associated with a corresponding one of the customers of the financial institution and a corresponding temporal interval, and may include, among other things a customer identifier associated with that corresponding customer and a temporal identifier representative of the corresponding temporal interval, as described herein within the validation interval Δt_{validation}. Further, and for each of the plurality of validation datasets 188, the corresponding customer may hold a credit product issued by the financial institution, and as described herein, the corresponding customer may be associated with a corresponding delinquency event that involves the issued credit product and that is initiating during the corresponding temporal interval, or remains pending, and unresolved, during at least a portion of the corresponding temporal interval.

In some instances, executed training input module 176 may parse candidate input data 186 to obtain the candidate composition of the input dataset, which not only identifies the candidate elements of customer-specific data included within each validation dataset (e.g., the candidate feature values described herein), but also a candidate sequence or position of these elements of customer-specific data within the validation dataset. Examples of these candidate feature values include, but are not limited to, one or more of the feature values extracted, obtained, computed, determined, or derived by executed training input module 176 and packaged into corresponding potions of training datasets 180, as described herein.

For example, executed training input module 176 may access the filtered data records maintained within second subset 1786, and based on portions of candidate input data 186, may perform any of the exemplary processes described herein to obtain or extract, or to compute, determine, or derive, the customer-specific feature values of the validation datasets. Executed training input module 176 may package each of the customer-specific feature values (e.g., as obtained, extracted, computed, determined, or derived from the filtered data records within second subset 178B) into corresponding positions within customer-specific ones of validation datasets 188, e.g., in accordance with the candidate sequence or position specified within candidate input data 186. Further, executed training input module 176 may perform any of the exemplary processes described herein to package, into an appropriate position within each of validation datasets 188, an element of ground-truth data indicative of occurrence, or non-occurrence, of a default event involving the corresponding customer and the credit product within a predetermined time period (e.g., the target temporal interval Δt_{target} described herein) subsequent to the occurrence of the corresponding delinquency event (e.g., temporal initiation point tᵢₙᵢₜ, as described herein).

In some instances, executed training input module 176 may perform any of the exemplary processes described herein to generate a corresponding one of validation datasets 188 associated with each combination of customer, temporal identifier, and delinquency event maintained within the filtered data records of second subset 178B. Although in other instances, executed training input module 176 may perform any of the exemplary processes described herein to generate a predetermined number of discrete validation datasets specified within candidate input data 186, or discrete validation data sets consistent with candidate input data 186 and associated with a predetermined set of customers.

Referring back to FIG. 1C, executed training input module 176 may provide the plurality of validation datasets 188 as inputs to executed adaptive training and validation module 182. In some examples, executed adaptive training and validation module 182 may perform operations that apply the adaptively trained, gradient-boosted, decision-tree process to respective ones of validation datasets 188 (e.g., based on the candidate model parameters within candidate model data 184, as described herein), and that generate elements of output data based on the application of the adaptively trained, gradient-boosted, decision-tree process to the respective ones of validation datasets 188.

As described herein, each of the each of elements of output data may be generated through the application of the adaptively trained, gradient-boosted, decision-tree process to a corresponding one of validation datasets 188, which includes, among other things, a customer identifier (e.g., identifying a corresponding customer of the financial institution), a temporal identifier (e.g., identifying a corresponding temporal interval), and an element of ground-truth data. Further, as described herein, each of elements of output data may be representative of a predicted likelihood of an occurrence of a default event involving the corresponding customer and a corresponding credit product issued by the financial institution within a predetermined time period (e.g., the target temporal interval Δt_{target} described herein) subsequent to an occurrence of a delinquency event involving the corresponding customer and the corresponding credit product (e.g., temporal initiation point tᵢₙᵢₜ, as described herein). In some instances, the predicted likelihood may be represented by a numerical score of zero (e.g., indicative of a minimal predicted likelihood) or unity (e.g., indicative of a maximum predicted likelihood).

Executed adaptive training and validation module 182 may perform operations that compute a value of one or more metrics that characterize a predictive capability, and an accuracy, of the adaptively trained, gradient-boosted, decision-tree process based on the generated elements of output data and corresponding ones of validation datasets 188. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, and additional, or alternatively, computed value of an AUC for a receiver operating characteristic (ROC) curve associated with the adaptively trained, gradient-boosted, decision-tree process. The disclosed embodiments are, however, not limited to these exemplary computed metric values, and in other instances, executed adaptive training and validation module 182 may compute a value of any additional, or alternate, metric appropriate to validation datasets 188, the elements of ground-truth data, or the adaptively trained, gradient-boosted, decision-tree process

In some examples, executed adaptive training and validation module 182 may also perform operations that determine whether all, or a selected portion of, the computed metric values satisfy one or more threshold conditions for a deployment of the adaptively trained, gradient-boosted, decision-tree process and a real-time application to elements of customer profile, account, transaction, collections, or credit-bureau data, as described herein. For instance, the one or more threshold conditions may specify one or more predetermined threshold values for the adaptively trained, gradient-boosted, decision-tree mode, such as, but not limited to, a predetermined threshold value for the computed recall-based values, a predetermined threshold value for the computed precision-based values, and/or a predetermined threshold value for the computed AUC values. In some examples, executed adaptive training and validation module 182 that establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, executed adaptive training and validation module 182 were to establish that one, or more, of the computed metric values fail to satisfy at least one of the threshold requirements, FI computing system 130 may establish that the adaptively trained, gradient-boosted, decision-tree process is insufficiently accurate for deployment and a real-time application to the elements of customer profile, account, transaction, insolvency, or credit-bureau data described herein. Executed adaptive training and validation module 182 may perform operations (not illustrated in FIG. 1B) that transmit data indicative of the established inaccuracy to executed training input module 176, which may perform any of the exemplary processes described herein to generate one or more additional training datasets and to provision those additional encrypted training datasets to executed adaptive training and validation module 182. In some instances, executed adaptive training and validation module 182 may receive the additional training datasets, and may perform any of the exemplary processes described herein to train further the gradient-boosted, decision-tree process against the elements of training data included within each of the additional training datasets.

Alternatively, if executed adaptive training and validation module 182 were to establish that each computed metric value satisfies threshold requirements, FI computing system 130 may deem the gradient-boosted, decision-tree process adaptively trained, and ready for deployment and real-time application to the elements of customer profile, account, transaction, collections, or credit-bureau data described herein. In some instances, executed adaptive training and validation module 182 may generate model data 190 that includes the model parameters of the adaptively trained, gradient-boosted, decision-tree process, such as, but not limited to, each of the candidate model parameters specified within candidate model data 184. Further, executed adaptive training and validation module 182 may also generate input data 192, which characterizes a composition of an input dataset for the adaptively trained, gradient-boosted, decision-tree process and identifies each of the discrete data elements within the input data set, along with a sequence or position of these elements within the input data set (e.g., as specified within candidate input data 186). As illustrated in FIG. 1C, executed adaptive training and validation module 182 may perform operations that store model data 190 and input data 192 within the one or more tangible, non-transitory memories of FI computing system 130, such as consolidated data store 144.

In some examples, the elements of training datasets 180 and validation datasets 188 may characterize an interaction between customers of the financial institution and corresponding ones of a plurality of credit products issued by the financial institution, may identify and characterize patterns in purchase transactions involving these credit products, and further, may identify delinquency events involving these customers and the issued credit products during corresponding temporal intervals. Examples of these issued credit products include, but are not limited to, credit-card accounts, home mortgages, auto loans, unsecured personal loans, secured or unsecured line-of-credits, and/or an overdraft protection (ODP) products. By leveraging training datasets 180 and validation datasets 188 associated with multiple credit products issued by the financial institution, the resulting, adaptively trained and validated gradient-boosted, decision-tree process may be capable of predicting the likelihood of occurrences of default events involving not a single credit product, but instead, any of a variety of different credit products held by corresponding customers of the financial institution.

Certain of these exemplary processes, which adaptively train and validate a gradient-boosted, decision-tree process simultaneously against training and validation data characterizing delinquency events involving a variety of distinct credit products, may be implemented in addition to, or as an alternate to, many existing processes that train and validate product-specific machine-learning or artificial-intelligence processes against product-specific training and validation datasets. Further, and when implemented in parallel by the distributed computing components of FI computing system 130, certain of these exemplary processes may reduce an amount of computational time and an amount of discrete computational operations required to adaptively train and validate a gradient-boosted, decision-tree process to predict the likelihood of occurrences of default events involving the variety of different credit products, when compared to existing processes that iteratively train and validate the existing product-specific machine-learning or artificial-intelligence processes against multiple sets of product-specific training and validation datasets.

### B. Exemplary Processes for Predicting Occurrences of Temporally Separated Events Using Adaptively Trained, Machine-Learning or Artificial-Intelligence Processes

In some examples, one or more computing systems associated with or operated by a financial institution, such as one or more of the distributed components of FI computing system 130, may perform operations that adaptively train a machine-learning or artificial-intelligence process to predict a likelihood of an occurrence of a default event involving a customer of the financial institution and a credit product issued by the financial institution within a predetermined time period subsequent to an occurrence of a delinquency event involving that customer and credit product. As described herein, the machine-learning or artificial-intelligence process may include an ensemble or decision-tree process, such as a gradient-boosted decision-tree process (e.g., the XGBoost model), and in some examples, the distributed computing components of FI computing system 130 may adaptively train the machine-learning or artificial-intelligence process using training datasets associated with a first prior temporal interval (e.g., a “training” interval) and validation datasets associated with a second, and distinct, prior temporal interval (e.g., an out-of-time “validation” interval). Responsive to a determination that the machine-learning or artificial-intelligence process is adaptively trained and ready for deployment, the distributed components of FI computing system 130 may perform any of the exemplary processes described herein to generate one or more elements of model data (e.g., model data 190 of FIG. 1C) that include the model parameters of the adaptively trained machine-learning or artificial-intelligence process, and to generate one or more elements of input data (e.g., input data 192 of FIG. 1C) that characterizes a composition of an input dataset for the adaptively trained machine-learning or artificial-intelligence process.

Further, the distributed components of FI computing system 130 may also perform any of the exemplary processes described herein to generate input datasets associated with a selected subset of the customers of the financial institution in accordance with the elements of input data. By way of example, the selected subset may include one or more customers of the financial institution that hold a credit product issued by the financial institution (e.g., one of the credit products described herein) and further, that are associated with a pending delinquency event involving the credit product. In some instances, the input data sets for each of the subset of the customers may include, among other things, a date associated with the occurrence of the corresponding delinquency event (e.g., the temporal initiation point tᵢₙᵢₜ, which include a due date of missed payment in the corresponding one of the credit products, etc.), a past-due temporal interval associated with the corresponding delinquency event (e.g., the past-due temporal interval Δt_{past-due}, as described herein), and a past-due balance associated with the corresponding delinquency event.

The distributed components of FI computing system 130 may also perform operations, described herein, to apply the adaptively trained machine-learning or artificial-intelligence process (e.g., the adaptively trained, gradient-boosted, decision-tree process described herein) to each of the input datasets in accordance with the elements of the model data, and based on the application of the adaptively trained machine-learning or artificial-intelligence process to each of the input datasets, to generate an element of output data associated with corresponding ones of the input data sets, and as such, with corresponding ones of the subset of customers. In some instances, each of the elements of output data may indicate of a predicted likelihood of occurrence of a default event involving the corresponding customer and the credit product held by the corresponding customer within a predetermined time period subsequent to an occurrence of the delinquency event involving the corresponding customer and the credit product (e.g., within 119 days of the occurrence of the delinquency event).

As described herein, each of the generated elements of output data may include a numerical score (e.g., either zero or unity) indicative of a predicted likelihood that the corresponding customer will be involved in the default event during the predetermined time period, e.g., with a score of zero being indicative of a predicted non-occurrence of the default event during the predetermined time period, and with a score of unity being indicative of a predicted occurrence of the default event during the predetermined time period. As described herein, FI computing system 130 may perform operations that, in conjunction with one or more additional computing systems of the financial institution, such as collections system 110, further process the elements of output data and identify one or more remediation processes or treatments that are applicable to the corresponding ones of the customers and appropriate to both the characteristics of the corresponding delinquency event and a predicted likelihood of the occurrence of a subsequent default event.

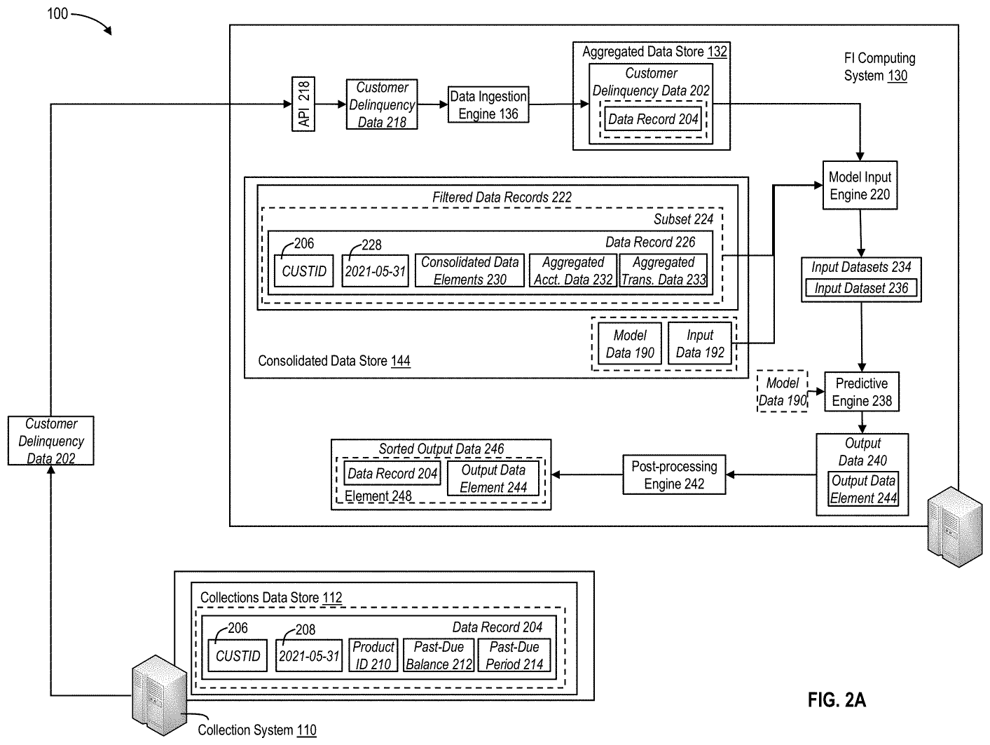

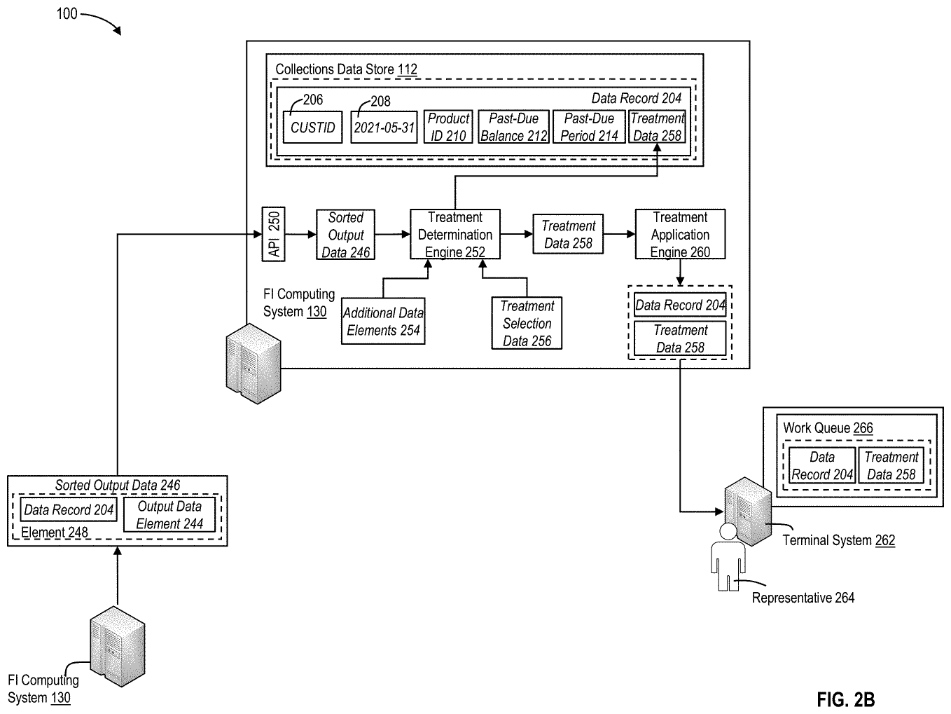

Referring to FIG. 2A, collections data store 112 of collections system 110 may maintain one or more structured or unstructured data records of customer delinquency data 202. Each of the data records of customer delinquency data 202 may be associated with a corresponding customer of the financial institution, and may include discrete elements of data that identify and characterize a pending delinquency event involving the corresponding customer and a credit product issued to the corresponding customer by the financial institution, such as, but not limited to, a credit-card account, a home mortgage, an auto loan, an unsecured personal loan, a secured or unsecured line-of-credit, or an overdraft protection (ODP) product.

By way of example, a particular customer of the financial institution may hold a credit-card account issued by the financial institution, and the credit-card account may be associated with $1,275 payment due on or before May 11, 2021. The particular customer may miss the $1,275 payment scheduled for May 11^{th}, which represents an occurrence of a delinquency event involving the particular customer and the credit-card account, and by May 31, 2021, the pending delinquency event may be associated with a past-due period (e.g., the past-due temporal interval Δt_{past-due}, as described herein) of twenty days, and a past-due balance of $1,475 (e.g., include the missed $1,275 payment and an additional $200 in interest and fees). In some instances, data record 204 of customer delinquency data 202 may identify and characterize the delinquency event involving the particular customer and the credit-card account, and may include, among other things, customer identifier 206 of the particular customer (e.g., an alphanumeric character string “CUSTID”), a temporal identifier 208 (e.g., a numerical string “2021-05-31”), and an identifier 208 of the credit-card account involved in the delinquency event (e.g., a product type, a portion of a tokenized account number, etc.).

Further, in some instances, data record 204 of customer delinquency data 202 may also include information that identifies and characterizes the pending delinquency event involving the particular customer and the credit-card account. For example, data record 204 may include past-due balance data 212 characterizing the $1,475 past-due balance associated with the delinquency event involving the particular customer and the credit-card account, and past-due period data 214 specifying that the delinquency event is associated with a past-due period of twenty days. The disclosed embodiments are, however, not limited these exemplary elements of data record 204, and other instances, data record 204 may include any additional or alternate elements of data that characterize the particular customer, the credit product, and the pending delinquency event involving the particular customer and credit product. Further, although not illustrated in FIG. 2A, each additional, or alternate, data records of customer delinquency data 202 may characterize and pending delinquency event involving a customer of the financial institution and a credit product issued to that customer, and may include any of the exemplary elements of data described herein that describe the customer, the issued credit product, and the pending delinquency event involving that customer and issued credit product.

An application program executed by the one or more processors of collections system 110 (not illustrated in FIG. 2A) may access collections data store 112, obtain all, or a selected portion of the data records of customer delinquency data 202, and transmit the obtained data records of customer delinquency data 202 across network 120 to FI computing system 130. In some instances, the executed application program may transmit the data records of customer delinquency data 202 across network 120 to FI computing system 130 in accordance with a predetermined temporal schedule, such as, but not limited to, at a predetermined time (e.g., 6:00 a.m.) on each business day. For example, collections system 110 and FI computing system 130 may perform operations that establish the predetermined temporal schedule, e.g., based on data pipelining requirements or capabilities. Further, although not illustrated in FIG. 2A, the executed application program may, prior to transmission across network 120 to FI computing system 130, encrypt the data records of customer delinquency data 202 using a corresponding encryption key, such as a public cryptographic key associated with FI computing system 130.

In some instances, a programmatic interface established and maintained by FI computing system 130, such as application programming interface (API) 218, may receive the data records of customer delinquency data 202 from collections system 110, and may route the data records of customer delinquency data 202 to executed data ingestion engine 136, which may perform operations that store the data records of customer delinquency data 202 within one or more tangible, non-transitory memories of FI computing system 130, such as within aggregated data store 132. In some instances, and as described herein, the received data records of customer delinquency data 202 may be encrypted, and executed data ingestion engine 136 may perform operations that decrypt each of the encrypted data records of customer delinquency data 202 using a corresponding decryption key (e.g., a private cryptographic key associated with FI computing system 130) prior to storage within aggregated data store 132.

As described herein, FI computing system 130 may perform any of the exemplary processes described herein to generate an input dataset associated with each of the customers identified by the data records of customer delinquency data 202, and to apply the adaptively trained, gradient-boosted, decision-tree process described herein to each of the input datasets. For example, on a daily basis and upon receipt of the data records of customer delinquency data 202, a model input engine 220 executed by FI computing system 130 may perform operations that access the data records of customer delinquency data 202 maintained within aggregated data store 132, and that obtain the customer identifier maintained within a corresponding one of the accessed the data records of customer delinquency data 202. As illustrated in FIG. 2A, executed model input engine 220 may access data record 204 (e.g., as maintained within aggregated data store 132) and obtain customer identifier 206, which includes, but is not limited to, the alphanumeric character string assigned to the corresponding customer of the financial institution.

Executed model input engine 220 may also access consolidated data store 144, and perform operations that identify, within filtered data records 222, a subset 224 of filtered data records that include customer identifier 206 and as such, are associated with the corresponding customer of the financial institution identified by data record 204. In some instances, each of subset 224 may include customer identifier 206 and as such, may be associated with the customer characterized by data record 204 of customer delinquency data 202. Each of subset 224 may also include a temporal identifier of a corresponding temporal interval, and one or more additional elements of consolidated data, aggregate account data, and/or aggregate transaction data that identify and characterize the corresponding customer and the interactions between the customer and the financial institution.

By way of example, data record 226 of subset 224 may also include corresponding temporal identifier 228 (e.g., “2021-05-31,” indicating a temporal interval spanning May 1, 2021, through May 31, 2021), and consolidated data elements 230, which identify and characterize the customer associated with customer identifier 206 during the temporal interval spanning May 1, 2021, through May 31, 2021. Data record 226 may also include elements of aggregated account data 232, which characterize the usage of the financial products or instruments held by the customer associated with customer identifier 206 during the temporal interval spanning May 1, 2021, through May 31, 2021, and elements of aggregated transaction data 233 characterizing a spending or purchasing habit of the customer associated with customer identifier 206 during the temporal interval spanning May 1, 2021, through May 31, 2021. Although not illustrated in FIG. 2A, data record 226 may include one or more data flags indicative of an established consistency of data record 226 with one or more filtration criteria, such as, but not limited to, the product and collections-specific filtering criteria described herein.

In some examples, FI computing system 130 may perform any of the exemplary process described herein to generate each of consolidated data elements 230, the elements of aggregated account data 232, and the elements of aggregated transaction data 233, and to package consolidated data elements 230, aggregated account data 232, and aggregated transaction data 233 into corresponding portions of data record 226 upon a determination that data record 226, and the customer associated with customer identifier 206, each satisfy one or more of the filtration criteria described herein during the temporal interval represented by temporal identifier 228. Further, although not illustrated in FIG. 2A, each additional, or alternate, data records within subset 224 may include customer identifier 206, a temporal identifier of a corresponding temporal interval, corresponding elements of consolidated data, aggregated account data, and transaction data that identify and characterize the particular customer during the corresponding temporal interval, and one or more data flags indicative of an established consistency of each of the additional, or alternate, data records with the one or more filtration criteria, such as, but not limited to, the product and collections-specific filtering criteria described herein.

Executed model input engine 220 may also perform operations that obtain, from consolidated data store 144, elements of input data 192 characterize a composition of an input dataset for the adaptively trained, gradient-boosted, decision-tree process. In some instances, executed model input engine 220 may parse input data 192 to obtain the composition of the input dataset, which not only identifies the elements of customer-specific data included within each input data set dataset (e.g., input feature values, as described herein), but also a specified sequence or position of these input feature values within the input dataset. Examples of these input feature values include, but are not limited to, one or more of the candidate feature values extracted, obtained, computed, determined, or derived by executed training input module 176, as described herein.

In some instances, and based on the parsed portions of input data 192, executed model input engine 220 may perform operations that identify, and obtain or extract, one or more of the input feature values from one or more of data records maintained within subset 224 of filtered data records 222 Executed model input engine 220 may also package the obtained, or extracted, input feature values within a corresponding one of input datasets 234, such as input dataset 236 associated with the particular customer identified by data record 204 of customer delinquency data 202, in accordance with their respective, specified sequences or positions. Further, in some examples, and based on the parsed portions of input data 192, executed model input engine 220 may perform operations that compute, determine, or derive one or more of the input features values based on elements of data extracted or obtained from the data records subset 224 of filtered data records 222, and that package each of the computed, determined, or derived input feature values into portions of input dataset 236 in accordance with their respective, specified sequences or positions.

Through an implementation of these exemplary processes, executed model input engine 220 may populate an input dataset associated with the corresponding customer identified by data record 204, such as input dataset 236 of input datasets 234, with input feature values obtained or extracted from, or computed, determined or derived from element of data within, the data records of subset 224. Further, in some instances, executed model input engine 220 may also perform any of the exemplary processes described herein to generate, and populate with input feature values, an additional one of input datasets 234 for each of the additional, or alternate, customers of the financial institution associated with additional, or alternate, data records of customer delinquency data 202. Executed model input engine 220 may package each of the discrete, customer-specific input datasets within input datasets 234, and executed model input engine 220 may provide input datasets 234 as an input to a predictive engine 238 executed by the one or more processors of FI computing system 130.

As illustrated in FIG. 2A, executed predictive engine 238 may perform operations that obtain, from consolidated data store 144, model data 190 that includes one or more model parameters of the adaptively trained, gradient-boosted, decision-tree process. For example, and as described herein, the model parameters included within model data 190 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

In some examples, and based on portions of model data 190, executed predictive engine 238 may perform operations that establish a plurality of nodes and a plurality of decision trees for the adaptively trained, gradient-boosted, decision-tree process, each of which receive, as inputs (e.g., “ingest”), corresponding elements of input datasets 234. Further, and based on the execution of predictive engine 238, and on the ingestion of input datasets 234 by the established nodes and decision trees of the adaptively trained, gradient-boosted, decision-tree process, FI computing system 130 may perform operations that apply the adaptively trained, gradient-boosted, decision-tree process to each of the input datasets of input datasets 234, including input dataset 236, and that generate an element of output data 240 associated with a corresponding one of input datasets 234, and as such, a corresponding one of the customers identified by the elements of customer delinquency data 202.

As described herein, each of the generated elements of output data 240 may include a numerical score indicative of a predicted likelihood that the corresponding one of the customers will be involved in a default event during the predetermined time period (e.g., the target temporal interval Δt_{target} of 119 calendar days, as described herein) subsequent to the occurrence of the delinquency event involving the corresponding one of the customers and the corresponding credit product. Further, a default event involving a corresponding one of the customers of the financial institution and a corresponding one of the credit products may, for example, occur when a scheduled payment associated with the corresponding one of the credit products remains past due for a past-due period (e.g., the past-due temporal interval Δt_{past-due}, as described herein) is equivalent to, or exceeds, a threshold past-due period, such as, but not limited to, ninety calendar days. In some examples, the numerical score within each of the elements of output data 240 may include a value of zero or a value of unity, with zero being indicative of a minimal predicted likelihood, and unity being indicative of a maximum predicted likelihood.

As illustrated in FIG. 2A, executed predictive engine 238 may provide the generated elements of output data 240 (e.g., either alone, or in conjunction with corresponding ones of input datasets 234) as an input to a post-processing engine 242 executed by the one or more processors of FI computing system 130. In some instances, and upon receipt of the generated elements of output data 240 (e.g., and additionally, or alternatively, the corresponding ones of input datasets 234), executed post-processing engine 242 may perform operations that access the elements of customer delinquency data 202 maintained within aggregated data store 132, and associate each of the elements of customer delinquency data 202 with a corresponding one of the elements of output data 240. By way of example, element 244 of output data 240 may be associated with the customer identified by data record 204 of customer delinquency data 202, and may include a numerical score of unity indicative of the predicted likelihood that the customer identified by data record 204 will be involved in a default event within the predetermined time period subsequent to the occurrence of the pending delinquency events involving the customer and the corresponding one of the credit products issued by the financial institution and held by that customer. Executed post-processing engine 242 may, in some instances, associate the customer identified by data record 204 of with element 244 of output data, and may perform any of these exemplary processes to associate each additional, or alternate, one of the elements of output data 240 with a corresponding one of the data records of customer delinquency data 202.

Further, and in some instances, executed post-processing engine 242 may perform operations that sort the associated data records of customer delinquency data 202 and elements of output data 240 based on the corresponding numerical scores, and output elements of sorted output data 246 that includes the associated, and now sorted, data records of customer delinquency data 202 and elements of output data 240. For example, and for the customer associated with customer identifier 206, sorted output data 240 may include a corresponding sorted element 248 that associates together data record 204 of customer delinquency data 202 (which includes customer identifier 206) and element 244 of output data 240 (which specifies a numerical score of unity for the customer associated with customer identifier 206). In some instances, by sorting the associated elements of data records of customer delinquency data 202 and the elements of output data 240 into respective bins indicative of a predicted non-occurrence of the default event within the predetermined time period of the corresponding one of the delinquency events (e.g., associated with a numerical score of zero), and indicative of a predicted occurrence of the default event within the predetermined time period of the corresponding one of the delinquency events (e.g., associated with a numerical score of unity), FI computing system 130 may identify those customers that represent a potential risk to the financial institution of default on a past-due balance associated within one or more credit products and as such, represent candidates for an application of one or more remediation processes or treatments to mitigate or reduce the potential default risk.

Referring to FIG. 2B, FI computing system 130 may perform operations that transmit all, or a selected portion of, sorted output data 246 across network 120 to collections system 110. A programmatic interface established and maintained by collections system 110, such as application programming interface (API) 250, may receive the elements of sorted output data 246, and may route the elements of sorted output data 246 to a treatment determination engine 252 executed by the one or more processors of collections system 110. In some instances, not illustrated in FIG. 2B, FI computing system 130 may also encrypt all, or a selected portion of, the elements of sorted output data 246 prior to transmission across network 120 using a corresponding encryption key (e.g., a public cryptographic key associated with collections system 110), and executed treatment determination engine 252 may perform operations that decrypt the encrypted elements of sorted output data 246 using a corresponding decryption key (e.g., a private cryptographic key associated with collections system 110).

In some instances, executed treatment determination engine 252 may perform operations that parse the elements of sorted output data 246 (including element 248) and that determine, for each of the customers of the financial institution that are involved in an pending delinquency event (e.g., and associated with respective ones of data records of customer delinquency data 202), one or more remediation processes or treatments that, if applied to the pending delinquency event, may resolve the pending delinquency event without any occurrence of a corresponding, predicted default event. Through the application of these remediation processes or treatments on a customer- and delinquent-event-specific basis, certain of these exemplary processes may enable collections system 110 to identify a first subset of the pending delinquency events that are unlikely to resolve prior to default, regardless of the applied remediation processor treatment, and to identify a second subset of the pending delinquency events amenable that are amenable to resolution via the application of an appropriate, customer-specific remediation process or treatment. Based on an implementation of these customer-specific remediation processes or treatments, collections system 110 may perform operations that resolve certain of the pending delinquency events prior to default and additionally, or alternatively, mitigate the financial losses associated with the pending delinquency events.

By way of example, executed treatment determination engine 252 may access element 248 of sorted output data 246, which associates together data record 204 of customer delinquency data 202 and output data element 244 (which specifies a numerical score of unity for the corresponding customer). As described herein, data record 204 may identify and characterize a delinquency event involving the corresponding customer (associated with customer identifier 206) and a credit-card account issued by the financial institution (e.g., associated with product identifier 210) that is ongoing and pending during a corresponding temporal interval between May 1, 2021, through May 31, 2021 (e.g., associated with temporal identifier 208). Data record 204 may also include information characterizing a scope of the pending delinquency event, such as past-due balance data 212 characterizing the $1,475 past-due balance associated with the pending delinquency event, and past-due period data 214 specifying that the delinquency event is associated with a past-due period of twenty days.

Executed treatment determination engine 252 may perform operations that obtain the numerical score associated the particular customer from output data element 244 (e.g., a score of unity, which indicates a predicted likelihood a default event involving the corresponding customer and the credit-card account will occur within the predetermined 119-day time period of the occurrence of the corresponding delinquency event), and that obtain customer identifier 206, temporal identifier 208, product identifier 210 (e.g., identifying the credit-card account), past-due balance data 212 (e.g., specifying the $1,475 past-due balance), and past-due period data 214 (e.g., specifying the a past-due period of twenty days). Furthermore, and based on customer identifier 206, executed treatment determination engine 252 may access additional elements 254 of customer profile, account, and/or transaction data (e.g., as maintained within collections data store 112) that identify and characterize the particular customer during the corresponding temporal interval. Based on additional elements 254, perform operations that generate data characterizing, among other things: a credit exposure of the financial institution due to the predicted occurrence of the default event involving the credit-card account held by the corresponding customer (e.g., a total balance associated with the credit-card account, etc.); an amount of credit available to the customer via the credit-card account associated with the pending delinquency event; a credit exposure of the financial institution across one or more additional, or alternate, secured or unsecured credit products held by the customer (e.g., a total balance across other credit products held by the particular customer); a total amount of credit extended to the customer across the other credit products; or a value of liquid assets available to the financial institution for offsetting potential losses (e.g., an available balance of funds within one or more demand deposit accounts, such as checking or savings accounts, etc.).

In some instances, executed treatment determination engine 252 may perform operations that compute an exposure score indicative of a level of risk posed, to the financial institution, by the predicted occurrence of the default event involving the particular customer and the credit-card account. The exposure score may range from zero to unity, with an exposure score of zero indicating that the potential default involving the particular customer and the credit-card account poses a minimum risk to the financial institution, and with an exposure score of unity indicating that the potential default involving the particular customer and the credit-card account poses a maximum risk to the financial institution. Further, executed treatment determination engine 252 may compute the exposure score as an arithmetic mean, a geometric mean, or a weighted average of a plurality of factors that characterize, among other things, the predicted likelihood of the occurrence of default involving the particular customer and the credit-card account, the magnitude of the past-due balance of the credit-card account, and a scope of an existing relationship with between the particular customer and the financial institution (e.g., as indicated by an outstanding balance on other credit products held by the particular customer of the financial institution or an amount of credit extended to the particular customer via these credit accounts).

For example, executed treatment determination engine 252 may compute the exposure score for the particular customer and the credit-card account (e.g., associated with element 248 of sorted output data 246) based on an arithmetic mean of: (i) the extracted numerical score associated the particular customer (e.g., a score of unity); (ii) a computed first ratio of the $1,475 past-due balance associated with the credit-card account (e.g., as specified past-due balance data 212) and the amount of credit available to the customer via the credit-card account (e.g., a $6,000 credit limit, as determined by executed treatment determination engine 252 based on additional elements 254); and (iii) a computed second ratio of the total balance across other credit products held by the particular customer (e.g., $7,000) and a total amount of credit extended to the customer across the other credit products (e.g., $10,000). Based on these exemplary processes, executed treatment determination engine 252 may compute an exposure score of 0.65 for the particular customer and the credit-card account. The disclosed embodiments are, however, not limited to these exemplary processes for computing the exposure score for the particular customer and credit-card account and in other instances, executed treatment determination engine 252 may compute the exposure score for the particular customer based on any additional or alternate factors appropriate to the particular customer, the type of credit product, the pending delinquency event, and the relationship between the particular customer and the financial institution.

Further, and based on the computed exposure score, executed treatment determination engine 252 may determine one or more remediation processes or treatments that, if applied to the pending delinquency event involving the corresponding customer and the credit-card account, may resolve that pending delinquency event without any occurrence of the corresponding default event. In some examples, executed treatment determination engine 252 may obtain, from the one or more tangible, non-transitory memories of collections system 110, elements of treatment selection data 256 that specify candidate remediation processes or treatments available for application to the pending delinquency event involving the particular customer and the credit-card account and further, that specify criteria for selecting one, or more, of the candidate remediation processes or treatments for application to the pending delinquency event based on the computed exposure score and certain factors specific to the particular customer, the credit-card account, or the pending delinquency event.

As described herein, the candidate remediation processes treatments may include, but are not limited to, generating and provisioning, to the corresponding customer, physical or electronic correspondence regarding the corresponding occurrence of the delinquency event (e.g., a physical letter, an email, a text-message, or an in-app notification, etc.), or initiating voice-based communications with the corresponding customer (e.g., via a pre-recorded message delivered by telephone, via a call manually generated by a representative of the financial institution). Further, in some instances, the candidate remediation processes or treatments may also include, among other things, withdrawing funds from one or more accounts of the corresponding customer based on a right of offset maintained by the financial institution, or performing operations that recover all, or a portion, of the past-due balance through interactions with a third-party collections agency. In other instances, the candidate remediation processes or treatments may include a deferral of any treatment of the delinquent customer or the delinquent financial product or instrument.

For example, for a numerical score of zero (e.g., as maintained within element 248 of sorted output data 246, and indicating a predicted non-occurrence of the default event), or for an exposure score of zero (e.g., indicating that the predicted occurrence of the default event involving the particular customer and the credit-card account poses a minimum risk to the financial institution), the elements of treatment selection data 256 may specify that the defer any application of remediation processes or treatments to the pending delinquency event involving the customer. In other examples, for a numerical score of unity (e.g., indicating a predicted occurrence of the default event), and for an exposure score between zero and 0.25, the elements of treatment selection data 256 may specify that the predicted occurrence of the default event poses a reduced level of risk to the financial institution, and may specify that the candidate remediation processes or treatment to the reduced risk level include, but are not limited to, provisioning of electronic correspondence to the particular customer regarding the pending delinquency event involving the credit-card account (an email, a text-message, or an in-app notification provisioned to a device of the particular customer, etc.) or an initiation of a pre-recorded, voice-based communication with the device.

In some examples, for a numerical score of unity and for an exposure score between 0.25 and 0.5, the elements of treatment selection data 256 may specify that the predicted occurrence of the default event poses a moderate level of risk to the financial institution, and may specify that the candidate remediation processes or treatment appropriate to the moderate risk level include, but are not limited to, a provisioning of electronic correspondence to the particular customer regarding the pending delinquency event (an email, a text-message, or an in-app notification provisioned to a device of the particular customer, etc.) or an initiation, by a representative of the financial institution, of a voice-based communication with the device. For a numerical score of unity and for an exposure score between 0.5 and 0.75, the elements of treatment selection data 256 may specify that the predicted occurrence of the default event poses a significant level of risk to the financial institution, and may specify that the candidate remediation processes or treatment appropriate to the significant risk level include, but are not limited to, the provisioning of physical correspondence to the particular customer regarding the pending delinquency event (e.g., a delivery of a physical letter to a residence of the particular customer, etc.) and the initiation, by the representative of the financial institution, of a voice-based communication with the device.

Further, and for a numerical score of unity and for an exposure score in excess of 0.75, the elements of treatment selection data 256 may specify that the predicted likelihood of the default event involving the corresponding customer and the credit-card account poses an extreme level of risk to the financial institution. In some instances, when the predicted occurrence of the default event poses an extreme risk to the financial institution, any actions taken by the financial institution may be incapable of preventing the predicted occurrence of the potential default event, and the elements of treatment selection data 256 may specify an application of one or more of the candidate remediation processes or treatments that allow the financial institution to recover all, or at least a portion, of the past-due balance. Examples of these candidate remediation processes or treatments include, but are not limited to, withdrawing funds from one or more accounts of the particular customer based on a right of offset maintained by the financial institution, or performing operations that recover all, or a portion, of the past-due balance through interactions with a third-party collections agency.

By way of example, and as described herein, executed treatment determination engine 252 may compute an exposure score of 0.65 for the particular customer and the credit-card account, and based on the elements of treatment selection data 256, executed treatment determination engine 252 may establish that the pending delinquency event involving the particular customer and the credit-card account represents a significant risk of financial loss to the financial institution. Further, and based on the elements of treatment selection data 256, executed treatment determination engine 252 may determine that the provisioning of physical correspondence to the particular customer regarding the pending delinquency event and the initiation, by the representative of the financial institution, of a voice-based communication with the customer's device, represent remediation processes or treatments appropriate to the significant risk of financial loss associated with the pending delinquency event. In some instances, executed treatment determination engine 252 may package, into corresponding potions of treatment data 258, information identifying the selected remediation processes or treatments, such as, but not limited to, the provisioning of physical correspondence to the particular customer regarding the pending delinquency event and the initiation, by the representative of the financial institution, of a voice-based communication with the device of the particular customer.

In some instances, executed treatment determination engine 252 may perform operations that parse the discrete data records of customer delinquency data 202 (e.g., as maintained within collections data store 112), and access data record 204 that includes customer identifier 206 and as such, is associated with the corresponding customer and the pending delinquency event that poses the significant risk of financial loss to the financial institution. Executed treatment determination engine 252 may also perform operations that augment accessed data record 204 to include treatment data 258, which identifies those remediation processes or treatments appropriate to the exposure score of, and the level of risk imposed by, the pending delinquency event involving the particular customer of the financial institution.

Executed treatment determination engine 252 may also provide at least a portion of data record 204 (e.g., customer identifier 206 or product identifier 210) and treatment data 258 to a treatment application engine 260 executed by the one or more processors of collections system 110, which may perform operations that implement those remediation processes or treatments appropriate to the exposure score of, and the level of risk imposed by, the pending delinquency event, e.g., the provisioning of physical correspondence to the particular customer regarding the pending delinquency event and the initiation, by the representative of the financial institution, of a voice-based communication with the device of the particular customer. By way of example, executed treatment application engine 260 may transmit treatment data 258 along with the portion of data record 204 across network 120 to a terminal system 262 operated by a representative 264 the financial institution. As and as illustrated in FIG. 2B, terminal system 262 may perform operations (e.g., via execution of stored software instructions by one or more corresponding processors) that store the portion of data record 204 and treatment data 258 within a portion of one or more tangible, non-transitory memories, such as within a portion of a work queue 266 of the representative.

The disclosed embodiments are, however, not limited to processes that transmit treatment data 258 and data record 204 to terminal system 262 for maintenance within work queue 266 of representative 264. For example, if treatment determination engine 252 were to establish that the predicted occurrence of the default event poses an extreme risk to the financial institution, treatment application engine 260 may perform operations that transmit portions of treatment data 258 and data record 204 across network 120 to one or more additional computing systems operated by the financial institution, which may perform operations that initiate a withdrawal of all, or a portion, of the $1,475 past-due balance from one or more accounts of the corresponding customer based on the right of offset maintained by the financial institution (e.g., in accordance with instructions packaged into portions of treatment data 258, which, when processed by the one or more additional computing systems, cause the one or more computing system to initiate the withdrawal).

In other examples, and based on the extreme risk posed by the predicted occurrence of the default event, treatment application engine 260 may perform operations that transmit portions of treatment data 258 and data record 204 across network 120 to one or more third-party computing systems (e.g., associated with a third-party collections agency), which may purchase a right to collect the outstanding $1,475 balance from the financial institution and mitigate the potential loss of that balance by the financial institution. Alternatively, if treatment determination engine 252 were to establish that the predicted occurrence of the default event poses an reduced risk to the financial institution, treatment application engine 260 may perform operations that initiate a channel of communications with one or more application programs executed by a device of the corresponding customer (e.g., a mobile banking application, etc.), and may generate and transmit to the device data identifying and characterizing the pending delinquency event, which the executed application program may present within a digital interface (e.g., as an in-app notification, etc.).

Executed treatment determination engine 252 may also perform any of the exemplary processes described herein to access each additional, or alternate, element of sorted output data 246, and to obtain a numerical score indicative of a predicted likelihood of an occurrence of a default event involving an additional customer and the corresponding credit product within a predetermined time period of an occurrence of corresponding, pending delinquency event. Based on at least the numerical scores, executed treatment determination engine 252 may perform any of the exemplary processes described herein to determine that one or more of the candidate remediation processes or treatments are appropriate to a level of risk of financial loss associated with each of the pending delinquency events, and to generate elements of treatment data that identify and characterize the corresponding ones of the appropriate the candidate remediation processes or treatments. In some instances, executed treatment determination engine 252 may provide each of the generated elements of treatment data as inputs to executed treatment application engine 260, which may perform any of the exemplary processes described herein to apply the appropriate the candidate remediation processes or treatments to corresponding ones of the pending delinquency events and the corresponding ones of the additional customers.

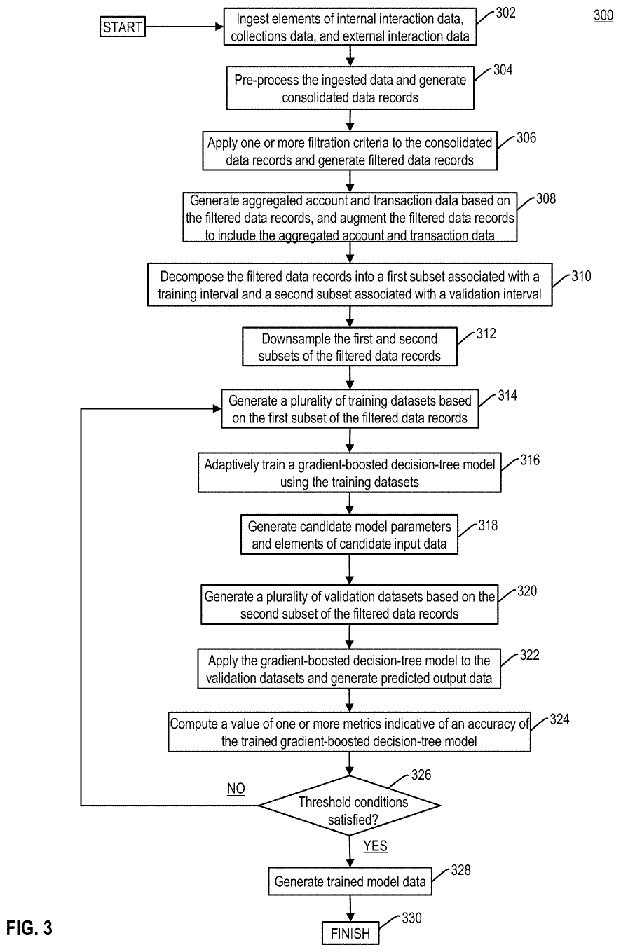

FIG. 3 is a flowchart of an exemplary process 300 for adaptively training a machine-learning or artificial-intelligence process to predict a likelihood of an occurrence of a default event involving a customer of a financial institution and a credit product issued by that financial institution within a predetermined time period subsequent to an occurrence of a delinquency event involving that customer and credit product. As described herein, the machine-learning or artificial-intelligence process may include an ensemble or decision-tree process, such as a gradient-boosted decision-tree process (e.g., the XGBoost model), and one or more of the exemplary, adaptive training processes described herein may utilize training datasets associated with a first prior temporal interval (e.g., a “training” interval), and validation datasets associated with a second, and distinct, prior temporal interval (e.g., an out-of-time “validation” interval). In some instances, one or more computing systems, such as, but not limited to, one or more of the distributed components of FI computing system 130, may perform one or of the steps of exemplary process 300.

Referring to FIG. 3, FI computing system 130 may establish a secure, programmatic channel of communication with one or more source computing systems, such as source systems 102 of FIG. 1A, and may perform operations to obtain, from the source computing systems, elements of internal interaction data, collections data, and external interaction data that identify and characterize one or more customers of the financial institution during corresponding temporal intervals (e.g., in step 302 of FIG. 3). FI computing system 130 may also perform operations that store (or ingest) the obtained elements of internal and external customer data within one or more accessible data repositories, such as aggregated data store 132 (e.g., also in step 302 of FIG. 3). In some instances, FI computing system 130 may perform the exemplary processes described herein to obtain and ingest the elements of elements of internal and external customer data in accordance with a predetermined temporal schedule (e.g., on a daily basis at a predetermined time, etc.), or a continuous streaming basis, across the secure, programmatic channel of communication.

Further, FI computing system 130 may perform any of the exemplary processes described herein to pre-process the ingested elements of internal interaction data, collections data, and external interaction data (e.g., the elements of customer profile, account, transaction, collections, and/or reporting or credit bureau data described herein) and generate one or more consolidated data records (e.g., in step 304 of FIG. 3). As described herein, the FI computing system 130 may store each of the consolidated data records within one or more accessible data repositories, such as consolidated data store 144 (e.g., also in step 304 of FIG. 3).

For example, and as described herein, each of the consolidated data records may be associated with a particular one of the customers, and may include a corresponding pair of a customer identifier associated with the particular customer (e.g., an alphanumeric character string, etc.) and a temporal interval that identifies a corresponding temporal interval. Further, and in addition to the corresponding pair of customer and temporal identifiers, each of the consolidated data records may also include one or more consolidated elements of customer profile, account, transaction, collections, or credit-bureau data that characterize the particular customer during the corresponding temporal interval associated with the temporal identifier.

In some instances, FI computing system 130 may perform any of the exemplary processes described herein to apply one or more filtration criteria to each of the consolidated data records, and to generate corresponding filtered data records that are consistent with, and satisfy, each of the applied filtration criteria (e.g., in step 306 of FIG. 1). As described herein, each of the filtered data records may be associated with a corresponding one of the customers, and may include a corresponding pair of a customer and temporal identifiers, such as those described herein. Further, and in addition to the corresponding pair of customer and temporal identifiers, each of the filtered data records may also include one or more of the consolidated elements of customer profile, account, transaction, collections, or credit-bureau data described herein, which characterize the corresponding one of the customers during the corresponding temporal interval associated with the temporal identifier.

By way of example, the filtration criteria may include one or more of the product- and collections-specific filtration criteria described herein, and each of the filtered data records may identify, and characterize, a corresponding one of the customers of the financial institution that holds a credit product issued by the financial institution, and that is associated a corresponding delinquency event involving the issued credit product. FI computing system 130 may store each of the filtered data records within one or more accessible data repositories, such as consolidated data store 144 (e.g., also in step 306 of FIG. 3).

FI computing system 130 may also perform any of the exemplary processes described herein to access each of the filtered data records, and based on the consolidated data elements maintained within each of the filtered data records, generate one or more elements of aggregated account data and one or more elements of aggregated account data that characterize the corresponding one of the customers during the corresponding temporal interval (e.g., in step 308 of FIG. 3). FI computing system 130 may also perform operations that augment each of the filtered data records to include the corresponding elements of aggregated account and transaction data (e.g., also in step 308).

In some instances, FI computing system 130 may perform any of the exemplary processes described herein to decompose the filtered data records into (i) a first subset of the consolidated data records having temporal identifiers associated with a first prior temporal interval (e.g., the training interval Δt_{training}, as described herein) and (ii) a second subset of the filtered data records having temporal identifiers associated with a second prior temporal interval (e.g., the validation interval Δt_{validation}, as described herein), which may be separate, distinct, and disjoint from the first prior temporal interval (e.g., in step 310 of FIG. 3). By way of example, portions of the filtered data records within the first subset may be appropriate to train adaptively the machine-leaning or artificial process (e.g., the gradient-boosted decision model described herein) during the training interval Δt_{training}, and portions of the filtered records within the second subset may be appropriate to validating the adaptively trained gradient-boosted decision model during the validation interval Δt_{validation}.

Further, and as described herein, the filtered data records within first subset or within the second subset may represent an imbalanced data set in which the actual occurrences of default events within the predetermined time period (e.g., the target temporal interval Δt_{target} described herein) subsequent to the occurrence of corresponding ones of the delinquency events are outnumbered disproportionately by non-occurrences of the default events during the target temporal interval Δt_{target}. Given the imbalanced character of the first and second subsets, FI computing system 130 may also perform any of the exemplary processes described herein to downsample the filtered data records within the first and second subsets that are associated with the non-occurrences of the default events during the target temporal interval Δt_{target} (e.g., in step 312 of FIG. 3). In some instances, the downsampled data records maintained within each of the first and second subsets may represent, respectively, a balanced data set characterized by a more proportionate balance between the occurrences, and non-occurrences, of the default events within the target temporal interval Δt_{target} subsequent to the occurrences of the corresponding delinquency events.

In some instances, FI computing system 130 may perform any of the exemplary processes described herein to generate a plurality of training datasets based on elements of data obtained, extracted, or derived from all or a selected portion of the first subset of the filtered data records (e.g., in step 314 of FIG. 3). By way of example, each of the plurality of training datasets may be associated with a corresponding one of the customers of the financial institution and a corresponding temporal interval, and may include, among other things a customer identifier associated with that corresponding customer and a temporal identifier representative of the corresponding temporal interval, as described herein. Further, and as described herein, each of the plurality of training datasets may also include elements of data (e.g., feature values) that characterize the corresponding one of the customers during the corresponding temporal interval, the corresponding customer's interaction with the financial institution or with other financial institution during the corresponding temporal interval, and one or more delinquency events involving the corresponding customer and a corresponding credit that occurred during, or remained pending during, at least a portion of the corresponding temporal interval. Each of the plurality of training datasets may also include an element of ground-truth data indicative of the occurrence, or nonoccurrence, of an actual default event involving the corresponding one of the customers (and the corresponding credit product) during the target temporal interval Δt_{target} (e.g., the predetermined 119-day period, as described herein) subsequent to the occurrence of the corresponding one of the delinquency events.

Based on the plurality of training datasets, FI computing system 130 may also perform any of the exemplary processes described herein to train adaptively the machine-learning or artificial-intelligence process (e.g., the gradient-boosted decision-tree process described herein) to predict a likelihood of an occurrence of default event involving a customer of a financial institution and a credit product issued by that financial institution within a predetermined time period subsequent to an occurrence of a delinquency event involving that customer and credit product (e.g., in step 316 of FIG. 3). For example, and as described herein, FI computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that adaptively train the gradient-boosted, decision-tree process against the elements of training data included within each of the plurality of the training datasets.

In some examples, the distributed components of FI computing system 130 may perform any of the exemplary processes described herein in parallel to establish the plurality of nodes and a plurality of decision trees for the gradient-boosted, decision-tree process, and to adaptively train the gradient-boosted, decision-tree process against the elements of training data included within each of the plurality of the training datasets. The parallel implementation of these exemplary adaptive training processes by the distributed components of FI computing system 130 may, in some instances, be based on an implementation, across the distributed components, of one or more of the parallelized, fault-tolerant distributed computing and analytical protocols described herein.

Through the performance of these adaptive training processes, FI computing system 130 may compute one or more candidate model parameters that characterize the adaptively trained machine-learning or artificial-intelligence process, such as, but not limited to, candidate model parameters for the adaptively trained, gradient-boosted, decision-tree process described herein (e.g., in step 318 of FIG. 3). In some instances, and for the adaptively trained, gradient-boosted, decision-tree process, the candidate model parameters included within candidate model data may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, FI computing system 130 may perform any of the exemplary processes described herein to generate candidate input data, which specifies a candidate composition of an input dataset for the adaptively trained machine-learning or artificial intelligence process, such as the adaptively trained, gradient-boosted, decision-tree process (e.g., also in step 318 of FIG. 3).

Further, FI computing system 130 may perform any of the exemplary processes described herein to access the second subset of the consolidated data records, and to generate a plurality of validation subsets having compositions consistent with the candidate input data (e.g., in step 320 of FIG. 3). As described herein, each of the plurality of the validation datasets may be associated with a corresponding one of the customers of the financial institution, and with a corresponding temporal interval within the validation interval Δt_{validation}, and may include a customer identifier associated with the corresponding one of the customers and a temporal identifier that identifies the corresponding temporal interval. Further, each of the plurality of the validation datasets may also include one or more feature values that are consistent with the candidate input data, associated with the corresponding one of the customers, and obtained, extracted, or derived from corresponding ones of the accessed second subset of the filtered data records.

In some instances, FI computing system 130 may perform any of the exemplary processes described herein to apply the adaptively trained machine-learning or artificial intelligence process (e.g., the adaptively trained, gradient-boosted, decision-tree process described herein) to respective ones of the validation datasets, and to generate corresponding elements of output data based on the application of the adaptively trained machine-learning or artificial intelligence process to the respective ones of the validation datasets (e.g., in step 322 of FIG. 3). As described herein, each of the generated elements of output data may be associated with a respective one of the validation datasets and as such, a corresponding one of the customers of the financial institution. Further, each of the generated elements of output data may also include a numerical score (e.g., ranging from zero to unity) indicative of a predicted likelihood that the corresponding one of the customers will experience, or will be involved in, a default event involving a credit product issued by that financial institution within a predetermined time period subsequent to an occurrence of a delinquency event involving that corresponding one of the customers and the credit product.

Further, and as described herein, the distributed components of FI computing system 130 may perform any of the exemplary processes described herein in parallel to validate the adaptively trained, gradient-boosted, decision-tree process described herein based on the application of the adaptively trained, gradient-boosted, decision-tree process (e.g., configured in accordance with the candidate model parameters) to each of the validation datasets. The parallel implementation of these exemplary adaptive validation processes by the distributed components of FI computing system 130 may, in some instances, be based on an implementation, across the distributed components, of one or more of the parallelized, fault-tolerant distributed computing and analytical protocols described herein.

In some examples, FI computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data and corresponding ones of the validation datasets (e.g., in step 324 of FIG. 3), and to determine whether all, or a selected portion of, the computed metric values satisfy one or more threshold conditions for a deployment of the adaptively trained machine-learning or artificial intelligence process (e.g., in step 326 of FIG. 3). As described herein, and for the adaptively trained, gradient-boosted, decision-tree process, the computed metrics may include, but are not limited to, one or more recall-based values (e.g., “recall@5,” “recall@10,” “recall@20,” etc.), one or more precision-based values for the adaptively trained, gradient-boosted, decision-tree process, and additionally, or alternatively, a computed value of an area under curve (AUC) for a precision-recall (PR) curve or a computed value of an AUC for a receiver operating characteristic (ROC) curve associated with the adaptively trained, gradient-boosted, decision-tree process.

Further, and as described herein, the threshold requirements for the adaptively trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC values. In some examples, FI computing system 130 may perform any of the exemplary processes described herein to establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, FI computing system 130 were to establish that one, or more, of the computed metric values fail to satisfy at least one of the threshold requirements (e.g., step 326; NO), FI computing system 130 may establish that the adaptively trained machine-learning or artificial-intelligence process (e.g., the adaptively trained, gradient-boosted, decision-tree process) is insufficiently accurate for deployment and a real-time application to the elements of customer profile, account, transaction, insolvency, or credit-bureau data described herein. Exemplary process 300 may, for example, pass back to step 314, and FI computing system 130 may perform any of the exemplary processes described herein to generate additional training datasets based on the elements of the consolidated data records maintained within the first subset.

Alternatively, if FI computing system 130 were to establish that each computed metric value satisfies threshold requirements (e.g., step 326; YES), FI computing system 130 may deem the machine-learning or artificial intelligence process (e.g., the gradient-boosted, decision-tree process described herein) adaptively trained and ready for deployment and real-time application to the elements of customer profile, account, transaction, collections, or credit-bureau data described herein, and may perform any of the exemplary processes described herein to generate trained model data that includes the candidate model parameters and candidate input data associated with the of the adaptively trained machine-learning or artificial intelligence process (e.g., in step 328 of FIG. 3). Exemplary process 300 is then complete in step 330.

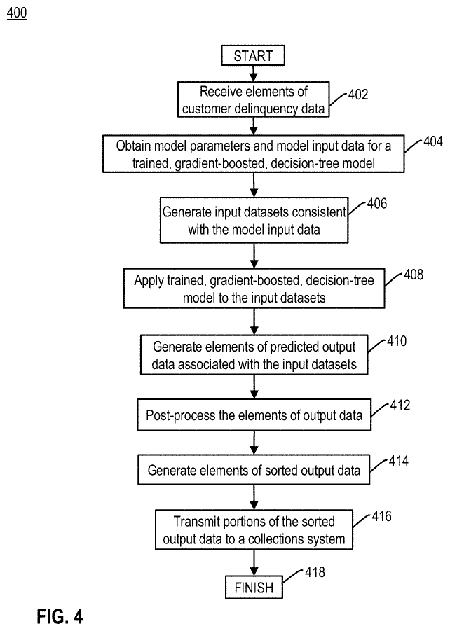

FIG. 4 is a flowchart of an exemplary process 400 for predicting a likelihood of an occurrence of a default event involving a customer of a financial institution and a credit product issued by that financial institution within a predetermined time period subsequent to an occurrence of a delinquency event involving that customer and credit product. As described herein, the machine-learning or artificial-intelligence process may include an ensemble or decision-tree process, such as a gradient-boosted decision-tree process (e.g., the XGBoost model), and one or more of the exemplary, adaptive training processes described herein may utilize, or leverage, training datasets associated with a first prior temporal interval (e.g., a “training” interval), and validation datasets associated with a second, and distinct, prior temporal interval (e.g., an out-of-time “validation” interval). In some instances, one or more computing systems, such as, but not limited to, one or more of the distributed components of FI computing system 130, may perform one or of the steps of exemplary process 300, as described herein.

Referring to FIG. 4, FI computing system 130 may perform any of the exemplary processes described herein to receive customer delinquency data from an additional computing system associated with the financial institution, such as collections system 110 (e.g., in step 402 of FIG. 4). As described herein, each element of the customer delinquency data (e.g., structured or unstructured data records, etc.) may be associated with a corresponding customer of the financial institution, and may include, among other things, a customer identifier of the corresponding customer, a temporal identifier of a corresponding temporal interval, and discrete elements of data that identify and characterize a pending delinquency event involving the corresponding customer of the financial institution and a credit product issued to that corresponding customer by the financial institution. Further, and as described herein, the elements of data that characterize each of the pending delinquency events may include, but are not limited to, an identifier of the involved credit product and data identifying a corresponding past-due balance and corresponding past-due period associated with the pending delinquency event.

In some instances, FI computing system 130 may perform any of the exemplary processes described herein to generate an input dataset associated with each of the customers identified by the data records of the customer delinquency data, and to apply the adaptively trained, gradient-boosted, decision-tree process described herein to each of the input datasets, in accordance with a predetermined temporal schedule, such as, at a predetermined time a daily basis. For example, FI computing system 130 may obtain one or more model parameters that characterize the adaptively trained machine-learning or artificial-intelligence process (e.g., the adaptively trained, gradient-boosted, decision-tree process described herein) and elements of model input data that specify a composition of an input dataset for the adaptively trained machine-learning or artificial-intelligence process (e.g., in step 404 of FIG. 4).

In some instances, and for the adaptively trained, gradient-boosted, decision-tree process described herein, the one or more model parameters may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, the elements of model input data may specify the composition of the input dataset for the adaptively trained, gradient-boosted, decision-tree process, which not only identifies the elements of customer-specific data included within each input data set dataset (e.g., input feature values, as described herein), but also a specified sequence or position of these input feature values within the input dataset.

FI computing system 130 may access filtered data records associated with one or more customers of the financial institution, and may perform any of the exemplary processes described herein to generate, for each of the one or more customers, an input dataset having a composition consistent with the elements of model input data (e.g., in step 406 of FIG. 4). In some instances, FI computing system 130 may generate the input datasets for each of these customers in accordance with the predetermined schedule described herein, such as, but not limited to, at the predetermined time on the daily basis).

Further, and based on the one or more obtained model parameters, FI computing system 130 may perform any of the exemplary processes described herein to apply the adaptively trained machine-learning or artificial-intelligence process (e.g., the adaptively trained, gradient-boosted, decision-tree process described herein) to each of the generated, customer-specific input datasets (e.g., in step 408 of FIG. 4), and to generate a customer-specific element of predicted output data associated with each of the customer-specific input datasets (e.g., in step 410 of FIG. 4). For example, and based on the one or more obtained model parameters, FI computing system 130 may perform operations, described herein, that establish a plurality of nodes and a plurality of decision trees for the adaptively trained, gradient-boosted, decision-tree process, each of which receive, as inputs (e.g., “ingest”), corresponding elements of the customer-specific input datasets. Based on the ingestion of the input datasets by the established nodes and decision trees of the adaptively trained, gradient-boosted, decision-tree process, FI computing system 130 may perform operations that apply the adaptively trained, gradient-boosted, decision-tree process to each of the customer-specific input datasets and that generate the customer-specific elements of the output data associated with the customer-specific input datasets.

As described herein, each of the customer-specific elements of output data may include a numerical score indicative of a predicted likelihood that the corresponding one of the customers will be involved in a default event during the predetermined time period (e.g., the target interval Δt_{target} of 119 calendar days, as described herein) subsequent to the occurrence of a delinquency event involving the corresponding one of the customers and the corresponding credit product. As described herein, a default event involving a corresponding one of the customers of the financial institution and a corresponding one of the credit products may, for example, occur when a scheduled payment associated with the corresponding one of the credit products remains past due for a past-due period (e.g., the past-due temporal interval Δt_{past-due}, as described herein) is equivalent to, or exceeds, a threshold past-due period, such as, but not limited to, ninety calendar days. In some examples, the numerical score within each of the customer-specific elements of output data may include a value of zero or a value of unity, with zero being indicative of a minimal predicted likelihood, and unity being indicative of a maximum predicted likelihood.

In step 412 of FIG. 4, FI computing system 130 may also perform any of the exemplary processes described herein to post-process the customer-specific elements of output data and, among other things, associate each of the customer-specific elements of output data with a corresponding data record of the received customer delinquency data. Further, FI computing system 130 may also perform any of the exemplary processes to sort the associated data records and customer-specific elements of output data based on magnitudes of the corresponding numerical scores, which indicate the predicted likelihood that corresponding one of the customers will be involved in a default event during the predetermined time period subsequent to the occurrence of the corresponding delinquency event (e.g., in step 414 of FIG. 4).

FI computing system 130 may perform any of the exemplary processes described herein to transmit all, or a selected portion of, the elements of sorted output data across network 120 to collections system 110 (e.g., in step 416 of FIG. 4). As described herein, collections system 110 may receive the elements of sorted output data from FI computing system 130, and may perform any of the exemplary processes described herein to that parse each of the elements of sorted output data to obtain a numerical score for a corresponding one of the customers of the financial institution, which may be associated a pending delinquency event involving a credit product issued by the financial institution. As described herein, each of the numerical scores may be indicative of a predicted likelihood that the corresponding one of the customers will be involved in a default event during the predetermined time period (e.g., the target interval Δt_{target} of 119 calendar days, as described herein) subsequent to the occurrence of the pending delinquency event. Based on the obtained numerical score, collections system 110 may perform any of the exemplary processes described herein to determine, for each of the corresponding customers, one or more remediation processes or treatments that, if implemented during the pending delinquency event, may resolve that pending delinquency event without any occurrence of the corresponding default event. Exemplary process 400 is then complete in step 418.

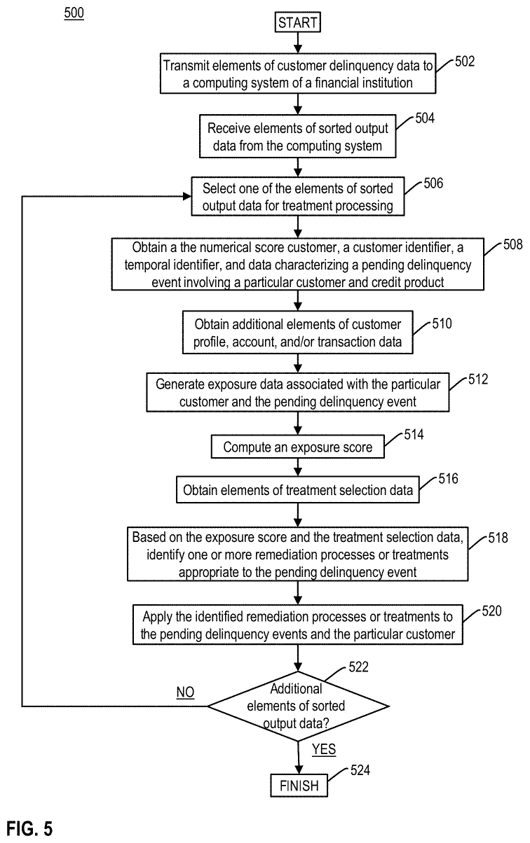

FIG. 5 is a flowchart of an exemplary process 500 for determining and implementing a remediation process or treatment appropriate to an ongoing delinquency event involving a customer of the financial institution and a corresponding credit product issued by the financial institution. In some instances, one or more computing systems, such as, but not limited to, collections system 110, may perform one or of the steps of exemplary process 500, as described herein.

Referring to FIG. 5, collections system 110 may perform any of the exemplary processes described herein to generate one or more elements of customer delinquency data (e.g., discrete data records, etc.), and to transmit the generated elements of elements of customer delinquency data across network 120 to FI computing system 130 (e.g., in step 502 of FIG. 5). In some instances, collections system 110 may perform operations that generate and transmit the elements of customer delinquency data to FI computing system 130 in accordance with a predetermined schedule, such as, but not limited to, on a daily basis at a predetermined time.

As described herein, each of the data records of the customer delinquency data may be associated with a corresponding customer of the financial institution, and may include discrete elements of data that identify and characterize a pending delinquency event involving the corresponding customer of the financial institution and a credit product issued to that corresponding customer by the financial institution. Examples of the credit product may include, but are not limited to, as a credit-card account, a home mortgage, an auto loan, an unsecured personal loan, a secured or unsecured line-of-credit, and/or an overdraft protection (ODP) product. Further, the pending delinquency event identified, and characterized, by each of the elements of customer delinquency data 202 may occur when the corresponding customer fails to submit a scheduled payment associated with the corresponding credit product (e.g., a scheduled monthly payment associated with an issued credit-card account).

Further, and as described herein, FI computing system 130 may receive the transmitted data records of the customer delinquency data, and may perform any of the exemplary processes described herein to generate a customer-specific input dataset associated with each of the corresponding customers characterized by respective ones of the data records of the customer delinquency data, and to apply the adaptively trained, gradient-boosted, decision-tree process described herein to each of the input datasets. Further, and based on the application of the adaptively trained, gradient-boosted, decision-tree process described herein to each of the input datasets, FI computing system 130 may perform any of the exemplary processes described herein to generate elements of output data, and each of the generated elements of output data may include a numerical score indicative of a predicted likelihood that a corresponding one of the customers will be involved in a default event during a predetermined time period (e.g., the target interval Δt_{target} of 119 calendar days, as described herein) of the occurrence of the delinquency event involving the corresponding customer and the corresponding credit product. FI computing system 130 may also perform any of the exemplary processes described herein to associate each of the generated elements of output data with a corresponding data record of the customer delinquency data, to sort the associated data records and elements of output data in accordance with the numerical scores, and to generate elements of sorted output data that includes corresponding ones of the sorted, and associated, data records and elements of output data. As described herein, FI computing system 130 may transmit the elements of sorted output data across network 120 to collections system 110.

Referring back to FIG. 5, collections system 110 may receive the elements of sorted output data from FI computing system 130 and may store the received elements of sorted output data within a locally accessible data repository (e.g., in step 504 of FIG. 5). In some instances, collections system 110 may select one of the elements of sorted output data associated with a particular customer of the financial institution for treatment processing (e.g., in step 506 of FIG. 5), and may perform operations that obtain, from the accessed elements of sorted output data, the numerical score associated the particular customer, a customer identifier of the particular customer, a temporal identifier of a corresponding temporal interval, and data characterizing the pending delinquency event involving the particular customer and corresponding credit product (e.g., in step 508 of FIG. 5). The data characterizing the pending delinquency event may include, among other things, a product identifier of the corresponding credit product, a past-due balance data, and a past-due period. Further, and based on the customer identifier, collections system 110 may obtain additional elements of customer profile, account, and/or transaction data that identify and characterize the particular customer during the corresponding temporal interval associated with the temporal identifier (e.g., in step 510 of FIG. 5).

Based on the additional elements of customer profile, account, and/or transaction data, collections system 110 may perform any of the exemplary processes described herein to generate exposure data associated with the particular customer and the pending delinquency event (e.g., in step 512 of FIG. 5), and based on the numerical score and the exposure data, collections system 110 may perform any of the exemplary processes described herein to compute a exposure score indicative of a level of risk posed, to the financial institution, by the predicted likelihood of the default event involving the particular customer and the credit-card account (e.g., in step 514 of FIG. 5). For example, the exposure score may range from zero to unity, with an exposure score of zero indicating that the potential default involving the particular customer and the credit-card account poses a minimum risk to the financial institution, and with an exposure score of unity indicating that the potential default involving the particular customer and the credit-card account poses a maximum risk to the financial institution.

Collections system 110 may also obtain elements of treatment selection data that specify candidate remediation processes or treatments available for application to the pending delinquency event involving the particular customer and the credit-card account and further, that specify criteria for selecting one, or more, of the candidate remediation processes or treatments for application to the pending delinquency event (e.g., in step 516 of FIG. 5). Based on at least the computed exposure score and the treatment selection data, collections system 110 may perform any of the exemplary processes described herein to identify one or more remediation processes or treatments that, if applied to the pending delinquency event involving the particular customer and the credit-card account, may resolve that pending delinquency event without any occurrence of the default event (e.g., in step 518 of FIG. 5).

As described herein, the candidate remediation processes treatments may include, but are not limited to, generating and provisioning, to the corresponding customer, physical or electronic correspondence regarding the corresponding occurrence of the delinquency event (e.g., a physical letter, an email, a text-message, or an in-app notification, etc.), or initiating voice-based communications with the corresponding customer (e.g., via a pre-recorded message delivered by telephone, via a call manually generated by a representative of the financial institution). Further, in some instances, the candidate remediation processes or treatments may also include, among other things, withdrawing funds from one or more accounts of the corresponding customer based on a right of offset maintained by the financial institution, or performing operations that recover all, or a portion, of the past-due balance through interactions with a third-party collections agency. In other instances, the candidate remediation processes or treatments may include a deferral of any treatment of the delinquent customer or the delinquent financial product or instrument.

Collections system 110 may also perform any of the exemplary processes described herein to apply the identified remediation processes or treatments to the pending delinquency event and the particular customer (e.g., in step 520 of FIG. 5). Collections system 110 may also determine whether additional elements of the sorted output data await processing and identification of appropriate remediation processes or treatments (e.g., in step 522 of FIG. 5).

If collections system 110 were to determine that additional elements of the sorted output data await processing (e.g., step 522; YES), exemplary process 500 may pass back to step 506, and collections system 110 may access an additional one of the elements of sorted output data associated with a particular customer of the financial institution for processing using any of the exemplary processes described herein. Alternatively, if collections system 110 were to determine no additional elements of the sorted output data await processing (e.g., step 522; no), exemplary process 500 is then complete in 524.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to, application programming interfaces (APIs) 134, 218, and 250, ingestion engine 136, pre-processing engine 140, filtration engine 152, aggregation engine 158, training engine 172, training input module 176, adaptive training and validation module 182, model input engine 220, predictive engine 238, post-processing engine 242, treatment determination engine 252, and treatment application engine 260, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
generate an input dataset based on elements of first interaction data, the elements of first interaction data characterizing an occurrence of a first event;
apply a trained artificial intelligence process to the input dataset, and based on the application of the trained artificial intelligence process to the input dataset, generate output data representative of a predicted likelihood of an occurrence of a second event within a predetermined time period subsequent to the occurrence of the first event; and
transmit at least a portion of the generated output data to a computing system via the communications interface, the computing system being configured to generate second interaction data specifying an operation associated with the occurrence of the first event based on the portion of the output data, and perform the operation in accordance with the second interaction data.

2. The apparatus of claim 1, wherein the at least one processor is further configured to:
receive at least a portion of the elements of the first interaction data from the computing system via the communications interface; and
store the received portion of the first interaction data within the memory.

3. The apparatus of claim 1, wherein the at least one processor is further configured to:
obtain (i) one or more parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more parameters.

4. The apparatus of claim 3, wherein the at least one processor is further configured to:
based on the data that characterizes the composition, perform operations that at least one of extract a first feature value from the elements of the first interaction data or compute a second feature value based on the first feature value; and
generate the input dataset based on at least one of the extracted first feature value or the computed second feature value.

5. The apparatus of claim 1, wherein:
the output data comprises a numerical score indicative of the predicted likelihood of the occurrence of the second event within the predetermined time period subsequent to the occurrence of the first event; and
the computing system is further configured to generate the second interaction data that specifies the operation associated with the occurrence of the first event based on the numerical score; and
the operation is consistent with the predicted likelihood of the occurrence of the second event.

6. The apparatus of claim 1, wherein the trained artificial intelligence process comprises a trained, gradient-boosted, decision-tree process.

7. The apparatus of claim 1, wherein:
the first interaction data is associated with a plurality of customers, each of the customers being associated with a corresponding occurrence of the first event; and
the at least one processor is further configured to execute the instructions to:
generate input datasets based on the first interaction data, each of the plurality of input datasets being associated with a corresponding one of the customers;
apply the trained artificial intelligence process to each of the plurality of input datasets, and based on the application of the trained artificial intelligence to each of the plurality of input datasets, generate an element of the output data representative of a predicted likelihood of a corresponding occurrence of the second event within the target temporal interval subsequent to the corresponding occurrence of the first event; and
each of the generated elements of output data includes a numerical score indicative of the predicted likelihood of the corresponding occurrence of the second event for a corresponding one of the customers.

8. The apparatus of claim 1, wherein the at least one processor is further configured to execute the instructions to:
obtain elements of third interaction data, each of the elements of the third interaction data comprising a temporal identifier associated with a temporal interval;
based on the temporal identifiers, determine that a first subset of the elements of the third interaction data are associated with a prior training interval, and that a second subset of the elements of the third interaction data are associated with a prior validation interval; and
generate training datasets based corresponding portions of the first subset, and perform operations that train the artificial intelligence process based on the training datasets.

9. The apparatus of claim 8, wherein the at least one processor is further configured to execute the instructions to:
generate validation datasets based on portions of the second subset;
apply the trained artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained artificial intelligence process.

10. The apparatus of claim 1, wherein:
the first event comprises a delinquency event involving a customer, and the second event comprises a default event involving the customer;
the default event occurs when a pendency period of the delinquency event exceeds a threshold period;
the output data is representative of a predicted likelihood of an occurrence of the default event within the predetermined time period of the occurrence of the delinquency event;
the operation comprises a remediation process associated with the delinquency event; and
the computing system is further configured to perform operations that implement the remediation process in accordance with the second interaction data and resolve the delinquency event based on the implementation of the remediation process.

11. A computer-implemented method, comprising:
generating, using at least one processor, an input dataset based on elements of first interaction data, the elements of first interaction data characterizing an occurrence of a first event;
using the at least one processor, applying a trained artificial intelligence process to the input dataset, and based on the application of the trained artificial intelligence process to the input dataset, generating output data representative of a predicted likelihood of an occurrence of a second event within a predetermined time period subsequent to the occurrence of the first event; and
transmitting, using the at least one processor, at least a portion of the generated output data to a computing system, the computing system being configured to generate second interaction data specifying an operation associated with the occurrence of the first event based on the portion of the output data, and perform the operation in accordance with the second interaction data.

12. The computer-implemented method of claim 11, further comprising:
receiving, using the at least one processor, at least a portion of the elements of the first interaction data from the computing system; and
storing, using the at least one processor, the received portion of the first interaction data within a data repository.

13. The computer-implemented method of claim 11, further comprising:
using the at least one processor, obtaining (i) one or more parameters that characterize the trained artificial intelligence process and (ii) data that characterizes a composition of the input dataset;
generating, using the at least one processor, the input dataset in accordance with the data that characterizes the composition; and
applying, using the at least one processor, the trained artificial intelligence process to the input dataset in accordance with the one or more parameters.

14. The computer-implemented method of claim 13, further comprising:
based on the data that characterizes the composition, performing, using the at least one processor, operations that at least one of extract a first feature value from the elements of the first interaction data or compute a second feature value based on the first feature value; and
generating, using the at least one processor, the input dataset based on at least one of the extracted first feature value or the computed second feature value.

15. The computer-implemented method of claim 11, wherein:
the output data comprises a numerical score indicative of the predicted likelihood of the occurrence of the second event within the predetermined time period subsequent to the occurrence of the first event; and
the computing system is further configured to generate the second interaction data that specifies the operation associated with the occurrence of the first event based on the numerical score; and
the operation is consistent with the predicted likelihood of the occurrence of the second event.

16. The computer-implemented method of claim 11, wherein the trained artificial intelligence process comprises a trained, gradient-boosted, decision-tree process.

17. The computer-implemented method of claim 11, wherein:
the first interaction data is associated with a plurality of customers, each of the customers being associated with a corresponding occurrence of the first event; and the computer-implemented method further comprises:
generating, using the at least one processor, input datasets based on the first interaction data, each of the plurality of input datasets being associated with a corresponding one of the customers; and
using the at least one processor, applying the trained artificial intelligence process to each of the plurality of input datasets, and based on the application of the trained artificial intelligence to each of the plurality of input datasets, generate an element of the output data representative of a predicted likelihood of a corresponding occurrence of the second event within the predetermined time period subsequent to the corresponding occurrence of the first event; and
each of the generated elements of output data includes a numerical score indicative of the predicted likelihood of the corresponding occurrence of the second event for a corresponding one of the customers.

18. The computer-implemented method of claim 11, further comprising:
obtaining, using the at least one processor, elements of third interaction data using the at least one processor, each of the elements of the third interaction data comprising a temporal identifier associated with a temporal interval;
based on the temporal identifiers, determining, using the at least one processor, that a first subset of the elements of the third interaction data are associated with a prior training interval, and that a second subset of the elements of the third interaction data are associated with a prior validation interval; and
generating, using the at least one processor, training datasets based corresponding portions of the first subset, and perform operations that train the artificial intelligence process based on the training datasets.

19. The computer-implemented method of claim 18, further comprising:
generating, using the at least one processor, validation datasets based on portions of the second subset;
applying, using the at least one processor, the trained artificial intelligence process to the plurality of validation datasets, and generate additional elements of output data based on the application of the trained artificial intelligence process to the plurality of validation datasets;
computing, using the at least one processor, one or more validation metrics based on the additional elements of output data; and
based on a determined consistency between the one or more validation metrics and a threshold condition, validating, using the at least one processor, the trained artificial intelligence process.

20. An apparatus, comprising:
a memory storing instructions;
a communications interface; and
at least one processor coupled to the memory and the communications interface, the at least one processor being configured to execute the instructions to:
transmit elements of first interaction data to a computing system via the communications interface, the elements of first interaction data characterizing an occurrence of a first event;
receive elements of output data from the computing system via the communications interface, the elements of output data being representative of a predicted likelihood of an occurrence of a second event within a predetermined time period subsequent to the occurrence of the first event; and the computing system being configured to generate the elements of output data based on an application of a trained artificial intelligence process to an input dataset comprising a subset of the elements of first interaction data;
based on the elements of output data, generate elements of second interaction data that specify one or more operations associated with the occurrence of the first event, and perform operations that implement the one or more specified operations in accordance with the elements of second interaction data.
